(19) United States
(12) Patent Application Publication
(10) Pub. No.: US 2026/0163954 A1
(43) Pub. Date: Jun. 11, 2026

(54) FIRST NODE, DEVICE, ENDPOINT, SECOND NODE, COMMUNICATIONS SYSTEM AND METHODS PERFORMED THEREBY FOR HANDLING INFORMATION IN THE COMMUNICATIONS SYSTEM

(71) Applicant: Telefonaktiebolaget LM Ericsson (publ), Stockholm (SE)

(72) Inventors: Miguel Angel MUN˜OZ DE LA TORRE ALONSO, Madrid (ES); Marcus IHLAR, Älvsjö (SE); Zaheduzzaman SARKER, Järfälla (SE)

(21) Appl. No.: 18/706,920

(22) PCT Filed: Nov. 10, 2021
(86) PCT No.: PCT/EP2021/081264

§ 371 Date: May 2, 2024

(51) Int. Cl. H04L 67/51

(52) U.S. Cl. CPC H04L 67/51

(57) ABSTRACT

A computer-implemented method, performed by a first node. The method is for handling information in a communications system. The first node operates in a communications system. The first node obtains, directly, or indirectly, from a second node operating in the communications system, information. The information corresponds to a subscriber linked to a device operating in the communications system. The information indicates a third node operating in the communications system having a capability to expose one or more services available at the communications system. The information further indicates at least a subset of the one or more services, allowed in the communications system to the subscriber. The first node provides the obtained information towards the device.

### TECHNICAL FIELD

The present disclosure relates generally to a first node and methods performed thereby for handling information in a communications system. The present disclosure also relates generally to a device, and methods performed thereby for handling information in the communications system. The present disclosure also relates generally to an endpoint, and methods performed thereby for handling information in the communications system. The present disclosure further relates generally to a second node, and methods performed thereby, for handling information in the communications system. The present disclosure additionally relates generally to a communications system and methods performed thereby for handling information in the communications system.

### BACKGROUND

Computer systems in a communications network or communications system may comprise one or more network nodes. A node may comprise one or more processors which, together with computer program code may perform different functions and actions, a memory, a receiving port and a sending port. A node may be, for example, a server. Nodes may perform their functions entirely on the cloud.

The communications system may cover a geographical area which may be divided into cell areas, each cell area being served by another type of node, a network node in the Radio Access Network (RAN), radio network node or Transmission Point (TP), for example, an access node such as a Base Station (BS), e.g. a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

The standardization organization Third Generation Partnership Project (3GPP) is currently in the process of specifying a New Radio Interface called Next Generation Radio or New Radio (NR) or 5G-UTRA, as well as a Fifth Generation (5G) Packet Core Network, which may be referred to as 5G Core Network (5GC), abbreviated as 5GC.

A 3GPP system comprising a 5G Access Network (AN), a 5GC and a UE may be referred to as a 5G system.

FIG. 1 is a schematic diagram depicting a particular example of a 5G reference architecture as defined by 3GPP, which may be used as a reference for the present disclosure. An Application Function (AF) 1 may interact with the 3GPP Core Network through a Network Exposure Function (NEF) 2. In case the AF may be trusted, e.g., internal to the network operator, the AF may interact with the 3GPP Core Network directly, with no NEF involved. The NEF 2 may support different functionality, e.g., different Exposure Application Program Interfaces (APIs), e.g., sponsored Data, Quality of Service (QoS), etc . . . , which may allow a content provider to request policies from the Mobile Network Operator (MNO). A Unified Data Repository (UDR) may store data grouped into distinct collections of subscription-related information: subscription data, policy data, structured data for exposure, and application data. The Policy Control Function (PCF) 3 may support a unified policy framework to govern the network behavior. Specifically, the PCF 3 may provide Policy and Charging Control (PCC) rules to the Policy and Charging Enforcement Function (PCEF), that is, the Session Management Function (SMF) 4/User Plane function (UPF) 5 that may enforce policy and charging decisions according to provisioned Policy and Charging Control (PCC) rules. The SMF 4 may support different functionalities, e.g., session establishment, modify and release, and policy related functionalities such as termination of interfaces towards policy control functions, charging data collection, support of charging interfaces and control and coordination of charging data collection at the UPF 5. Specifically, the SMF 4 may receive the PCC rules from the PCF 3 and may configure the UPF 5 accordingly through an N4 6 reference point, Packet Flow Control Protocol (PFCP) protocol. The UPF 5 may support handling of user plane traffic based on the rules received from the SMF 4, e.g. packet inspection through Packet Detection Rules (PDRs) and different enforcement actions such as, e.g. traffic steering, QoS, Charging/Reporting through Forwarding Action Rules (FARs), QoS Enforcement Rules (QERs), and/or Usage Reporting Rule (URRs). The PCF 3 may provide policy rules to a UE 7 through the Access and Mobility Function (AMF) 8. The AMF 8 may manage access of the UE 7. For example, when the UE 7 may be connected through different access networks, and mobility aspects of the UE 7. Also depicted in FIG. 1 is a Network Slice Selection Function (NSSF) 9, Network Repository Function (NRF) 10, a Unified Data Management (UDM) 11, an Authentication Server Function (AUSF) 12, a Radio Access Network (RAN) 13, and a Data Network (DN) 14. Each of the NSSF 9, the NEF 2, the NRF 10, the PCF 3, the UDM 11, the AF 1, the AUSF 12, the AMF 8, the SMF 4, the UE 7, the RAN 13, the UPF 5 and the DN 14 may have an interface through which they may be accessed, which as depicted in the Figure, may be, respectively: Nnssf 15, Nnef 16, Nnrf 17, Npcf 18, Nudm 19, Naf 20, Nausf 21, Namf 22, Nsmf 23, N1 24, and N2 25. The RAN 13 may have an interface N3 26 with the UPF 5. The UPF 5 may have an interface N6 27 with the DN 14.

The Common Application Program Interface Framework (CAPIF) may be understood to allow a content provider, acting as an AF or Application Programming Interface (API) invoker, to request different MNO services, e.g., through different APIs, as schematically depicted in FIG. 2. As stated in 3GPP TS 23.222, v. 17.5.0, a CAPIF-1e reference point 20, which may exist between the API invoker 21 and the CAPIF core function 22, may be used for the API invoker 21 outside the Public Land Mobile Network (PLMN) trust domain 23 to discover service APIs 24, to authenticate and to get authorization. The Service APIs 24 may belong to an API provider domain 25, which may further comprise an API exposing function 26, an API publishing function 27, and an API management function 28. Also depicted in FIG. 2 are the different interfaces between these components: CAPIF-1 29, between the API invoker 30 inside the PLMN Trust domain 23 and the CAPIF APIs 31, CAPIF-2 32 between the API invoker 30 inside the PLMN Trust domain 23 and the Service APIs 24, CAPIF.2e 33 between the API invoker 21 outside the PLMN Trust domain 23 and the Service APIs 24, CAPIF-3 34 between the CAPIF core function 22 and the API exposing function 26, CAPIF-4 35 between the CAPIF core function 22 and the API publishing function 27, and CAPIF-5 36 between the CAPIF core function 22 and the API management function 25.

### Traffic Encryption and Network Management

Traffic encryption is growing significantly in mobile networks and at the same time, the encryption mechanisms are growing in complexity. In particular, most applications today may not be based on Hypertext Transport Protocol (HTTP) cleartext, but instead they may be based on Hypertext Transport Protocol Secure (HTTPS) using Transport Layer Security (TLS). Additionally, a significant part of the traffic may be based on Quick UDP Internet Connection (QUIC) transport, which may be understood to have an encryption level higher than TLS. In the future, it is foreseen that most applications will be based on QUIC transport.

### QUIC

QUIC may be basically understood to be a UDP based stream-multiplexed and secure transport protocol with integrity protected header and encrypted payload. Unlike the traditional transport protocol stack with Transmission Control Protocol (TCP), which may reside in the operating system kernel, QUIC may easily be implemented in user space, e.g., in the application layer. As a consequence, this may improve flexibility in terms of transport protocol evolution with implementation of new features, congestion control, deploy ability and adoption.

QUIC is currently undergoing standardization in the Internet Engineering Task Force (IETF). QUIC is likely to become the main transport protocol in the user plane of the Internet. It is expected that most applications running today over HTTP/HTTPS will migrate to QUIC, driven by latency improvements and stronger security. Notably, compared to HTTPS, encryption in QUIC may cover both the transport protocol headers as well as the payload, as opposed to TLS over TCP, e.g. HTTPS, which may protect only the payload.

### Proxy

Conceptionally, a proxy may be understood to be an intermediary program acting as both server and client, creating or simply relaying requests on behalf of other entities. Requests may be serviced internally or by passing them on, with possible translation, to other servers. There may be several types of proxies, such as a transparent proxy, a non-transparent proxy, a reverse proxy and a “Performance Enhancement Proxy (PEP)”. A “transparent proxy” may be understood as a proxy that may not modify the request or response beyond what may be required for proxy authentication and identification. A “non-transparent proxy” may be understood as a proxy that may modify the request or response to provide some added service to the user agent, such as group annotation services, media type transformation, protocol reduction, or anonymity filtering. A “reverse proxy” may be basically understood as a proxy that may pretend to be the actual server, as far as any client or client proxy may be concerned, but it may pass on the request to the actual server that may be usually sitting behind another layer of firewalls. A PEP may be used to improve the performance of protocols on network paths where native performance may suffer due to characteristics of a link or subnetwork on the path.

### IETF MASQUE and Collaborative Performance Enhancement (COPE)

IETF has created a new Working Group called Multiplexed Application Substrate over QUIC Encryption (MASQUE), aimed to develop mechanism(s) that may allow configuring and concurrently running multiple proxied stream-and datagram-based flows inside an HTTPS connection. These mechanism(s) are collectively called MASQUE. The group will specify HTTP and/or HTTP/3 extensions to enable this functionality.

A COPE node or function may be understood as an entity which may reside between two endpoints, usually in a client and server setup but also in a peer to peer communication setup, that may use encrypted communication. The communicating parties, usually the client, may explicitly contact the proxy in order to request a network-support service. This service at a minimum may always include forwarding of the encrypted traffic to a specific server, e.g. also in cases where the server may otherwise not be directly reachable. In addition, the endpoints may share traffic information with the COPE entity such that the COPE entity may execute a requested performance enhancement function to improve the QoS of the traffic as well as optimize operations within the network. Alternatively, also the COPE node may provide additional information about the network which may enable the endpoint to optimize its data transfer, e.g. use a more optimized congestion control or delay pre-fetching activities.

Usually, it is expected that a client may learn about the existence of a COPE service either directly from the access network or by other communication with a peer. When a COPE node is detected, the client may open a connection to it, for example a QUIC connection when QUIC may be used as a transport protocol and request a service. The communication with the server may be realized by an inner transport connection that may be encrypted end-to-end between the client and the server.

By using the above mechanisms, an application may create a secure connection to an on-path network proxy, and establish secure End-to-End (E2E) connection to the server(s) via the proxy. Application data may be secured E2E and protected from unauthorized used in the network. A content provider and an MNO may have a secure channel to exchange information about application and policy real-time.

The application client may explicitly open a QUIC tunnel connection to the proxy and request forwarding and use an HTTP CONNECT-like protocol and a custom protocol to request or negotiate forwarding, authentication, and configuration.

A QUIC proxy may provide secure forwarding and performance enhancement services, e.g., congestion control support, e.g., mobile and/or satellite, access policy enforcement, load balancing and/or mobility, multi-hop chaining and/or onion routing. A QUIC proxy may optionally also open a tunnel to a server, if supported by a server.

By using the above mechanisms, the client and/or server, usually the client, may explicitly contact a proxy, e.g., a QUIC Proxy, in order to expose information between the content provider, e.g., an application client and/or server, and the MNO, e.g., a QUIC Proxy at a UPF. FIG. 3 is a schematic diagram of a client/server and proxy interaction. FIG. 3 particularly shows an inner connection 37 which carries encrypted application traffic between a client 38 and a server 39, not visible to the proxy 40, while an outer connection 41 may be used to expose information between the content provider, that is, the application client and/or Server, and the MNO, e.g., QUIC Proxy at the UPF. The outer connection 41 and the inner connection 37 may connect the client 38 and the QUIC proxy 40 over an access network 42, and the between the QUIC proxy 40 and the server 39 over an internet connection 43.

### Application-Network Interaction Function (ANIF), MNO AF

3GPP TS 26.501, Rel. 16, v16.8.0, as part of the 5G Media Streaming (5GMS) architecture schematically shown in FIG. 4, has defined a solution which may allow a content provider, e.g., an application client at a UE 44 or 5GMS Aware Application 45, through a 5GMS client 46, to request dynamic policies, on a per application basis, to be enforced by a MNO, through an MNO AF, e.g., a 5GMS AF 47.

The interface between the content provider, e.g., an application client at the UE 44, and the MNO, e.g., an MNO AF, has been defined by 3GPP as a Dynamic Policies API, which may allow the content provider, e.g., the application client at the UE 44, to request a specific policy and charging treatment to be applied to a particular application data flow by invoking RESTful operations on the MNO AF, e.g., the 5GMS AF 47, at interface M5d. The API may define a set of data models, resources and the related procedures for the creation and management of the dynamic policy request. As depicted in FIG. 4, the UE 44 may connect via a Uu interface 48 to a RAN 49. The RAN 49 may connect via an N3 interface 50 to a UPF 51. The UPF 51 may in turn connect, via an N6 interface 52 to a Trusted Data Network (DN) 53, and via another N6 interface 54 to an External DN 55. Each of the Trusted DN 53 and the External DN 55 may comprise a respective 5GMS AF 47 and a 5GMS Application Server (AS) 56. Each of the respective 5GMS AFs may be connected via a respective N33 interface 57 to a NEF 58. The 5GMS AF 59 in the trusted DN 53 may be also connected via an N5 interface 60 to a PCF 61.

As part of 3GPP Rel 17 Enablers for Network Automation Phase 2(eNAPh2), 3GPP has defined a solution which may allow the MNO, through an MNO AF, to trigger analytics data collection from a content provider, e.g., an application client at a UE. This is referred as Solution #27 in 3GPP TR 23.700-91, v. 17.0.0. The network architecture for this solution is schematically shown in FIG. 5 below. FIG. 5 is a schematic diagram depicting an example of an analytics data collection from an application client based on an MNO AF. As depicted in FIG. 5, an Application Service Provide (ASP) application client 62 in a UE 63 may connect with application ASP in an external DN 64 via an Uu interface 65 to a RAN 66. The RAN 66 may be connected via an N3 interface N3 67 to a UPF 68. The UPF 68 may in turn be connected via an N6 interface 69 to the external DN 64. The UPF 68 may be also connected via N6 interface 70 to an MNO AF 71, which may in turn be connected to a Network Data Analytics Function (NWDAF) 72. An application server 73 in the external DN 64 may have a direct logical connection to the UE 63.

Both solutions above are based the MNO AF described in both 3GPP solutions above, which may be referred to as Application to Network Interaction Function (ANIF). In either of these approaches, services provided by the network operators may not always be discoverable.

### SUMMARY

As part of the development of embodiments herein, one or more challenges with the existing technology will first be identified and discussed.

As stated earlier, a NEF may expose a set of APIs for third party content/application providers to interact with an operator network. To make use of the APIs provided by NEF, an application server, or application function, may need to know which mobile operator network may be being used by a client requesting application resources. As an example, when an application server, e.g., the AS of a movie streaming provider, may receive traffic for a certain application session e.g., of the movie streaming provider, the AS may not know which MNO may handle that traffic, so it may not know which NEF to contact, that is, which NEF of which MNO to contact.

The CAPIF framework may assume there is a Service Level Agreement (SLA) between the content provider, e.g., the AF, and the MNO, e.g., the NEF, so the content provider may know, e.g., as part of the SLA, the address of the MNO entry point, that is, the CAPIF core function, through CAPIF-1e. When there is no SLA, this is not possible. One example to illustrate this may be a user browsing an example.com site through a browser. Example.com, acting as AF, may want to trigger an Nnef “AS Session with QoS” API, but does not know which CAPIF Core Function, through CAPIF-1e, and NEF, through CAPIF-2e, instances to contact. Additionally, as mentioned above, the AF does not know which MNO to contact.

The above may be understood to mean that the application server may need to either be positioned in the network edge or that it may need to use other contextual information to determine which NEF instance to contact, e.g., through HTTP Header Enrichment by UPF inserting the Mobile Country Code (MCC)-Mobile Network Code (MNC), but this may be no longer valid due to HTTPS/QUIC encryption.

In existing methods, the server, e.g., the App server/Application Function (AS/AF), e.g. a movie streaming provider, may only see the source Internet Protocol (IP) address from the received packets, which may not identify the MNO, e.g., “MNO A” or “MNO B”; hence, if the AS/AF wants to trigger a Nnef “AS Session with QoS” API, e.g., to provide high QoS to the movie streaming provider traffic, it does not know which MNO's CAPIF Core Function and/or NEF to contact to.

According to the foregoing, there may be two problems related to NEF discovery. A first problem may be understood to be for an AF to discover the MNO, e.g., MNO “A”. This may be usually solved through content enrichment, e.g., an HTTP Header Enrichment by a UPF, with the MNO identifier, e.g., MNC-MCC value. But with HTTPS or QUIC traffic this may not be possible.

The second problem may for the AF to discover the CAPIF Core Function and/or NEF Instance, for the discovered MNO in the previous step, e.g., MNO “A”.

The above problems may apply both when there may be no SLA between the content provider and the MNO. This is a relevant scenario as there may be myriads of content providers, and the MNO may not be able to manage having SLAs for all of them.

The above problems may also apply when there may be an SLA between the content provider and the MNO, but the content provider may not know which MNO to contact. This scenario may be understood to be relevant due to encryption. Usually, the MNO may apply content enrichment, e.g., HTTP Header Enrichment by a UPF, with the MNO identifier, e.g., MNC-MCC value. In case of encrypted traffic, e.g., HTTPS, QUIC, this is not possible.

This may be understood to pose a constraint for deployability and applicability of NEF interfaces. The consequence of the above problems may be understood to be that services provided by the network operators are not discoverable and usable both by new applications, e.g., for which there may be no SLA in place, and by applications for which there may be an SLA in place.

According to the foregoing, it is an object of embodiments herein to improve the handling information in a communications system.

According to a first aspect of embodiments herein, the object is achieved by a computer-implemented method, performed by a first node. The method is for handling information in a communications system. The first node operates in a communications system. The first node obtains, directly, or indirectly, from a second node operating in the communications system, information. The information corresponds to a subscriber linked to a device operating in the communications system. The information indicates a third node operating in the communications system. The third node has a capability to expose one or more services available at the communications system. The information also indicates at least a subset of the one or more services, allowed in the communications system to the subscriber. The first node then provides the obtained information towards the device.

According to a second aspect of embodiments herein, the object is achieved by a computer-implemented method, performed by the device. The method is for handling the information in the communications system. The device operates in the communications system. The device obtains, directly, or indirectly, from the first node operating in the communications system, the information corresponding to the subscriber linked to the device. The information indicates the third node operating in the communications system having the capability to expose the one or more services available at the communications system. The information also indicates at least the subset of the one or more services, allowed in the communications system to the subscriber. The device then provides the obtained information to an endpoint of a data session with the device. The endpoint operates outside of the communications system.

According to a third aspect of embodiments herein, the object is achieved by a computer-implemented method, performed by the endpoint. The method is for handling information in the communications system. The endpoint operates outside the communications system. The endpoint obtains, from the device operating in the communications system, the information corresponding to the subscriber linked to the device. The information indicates the third node operating in the communications system having the capability to expose the one or more services available at the communications system. The information also indicates at least a subset of the one or more services, allowed in the communications system to the subscriber. The endpoint also sends an indication to the third node indicated in the information. The indication requests the one of the one or more services in the subset.

According to a third aspect of embodiments herein, the object is achieved by a computer-implemented method, performed by the second node. The method is for handling information in the communications system. The second node operates in the communications system. The second node receives a request identifying a device. The second node then queries the fourth node operating in the communications system for information corresponding to the subscriber linked to the device. The second node obtains the information from the fourth node. The information indicates the third node operating in the communications system having the capability to expose the one or more services available at the communications system. The information also indicates at least the subset of the one or more services, allowed in the communications system to the subscriber. The second node also provides the obtained information towards the device or to the first node operating in the communications system.

According to a fourth aspect of embodiments herein, the object is achieved by a computer-implemented method, performed by the communications system. The method is for handling information in the communications system. The communications system comprises the first node, the second node and the device. The method comprises obtaining, by the first node, directly, or indirectly, from the second node operating in the communications system, the information. The information corresponds to the subscriber linked to the device operating in the communications system. The information indicates the third node operating in the communications system. The third node has the capability to expose the one or more services available at the communications system. The information also indicates at least the subset of the one or more services, allowed in the communications system to the subscriber. The method also comprises providing, by the first node, the obtained information towards the device. The method then comprises obtaining, by the device, the information directly, or indirectly, from the first node. The method also comprises providing, by the device, the obtained information to the endpoint of the data session with the device. The endpoint operates outside of the communications system. The method also comprises obtaining, by the endpoint, the information from the device operating in the communications system corresponding to the subscriber linked to the device. The method also comprises sending, by the endpoint, the indication to the third node indicated in the information. The indication requests the one of the one or more services in the subset.

According to a fifth aspect of embodiments herein, the object is achieved by the first node, for handling information in the communications system. The first node is configured to operate in the communications system. The first node is further configured to obtain, directly, or indirectly, from the second node configured to operate in the communications system, the information. The information corresponds to the subscriber configured to be linked to the device configured to operate in the communications system. The information is configured to indicate the third node configured to operate in the communications system. The third node is further configured to have the capability to expose the one or more services configured to be available at the communications system. The information is configured to indicate at least the subset of the one or more services, configured to be allowed in the communications system to the subscriber. The first node is further configured to provide the information configured to be obtained towards the device.

According to a sixth aspect of embodiments herein, the object is achieved by the device, for handling information in the communications system. The device is configured to operate in the communications system. The device is further configured to obtain, directly, or indirectly, from the first node configured to operate in the communications system, the information corresponding to the subscriber configured to be linked to the device. The information is configured to indicate the third node configured to operate in the communications system. The third node is further configured to have the capability to expose the one or more services configured to be available at the communications system. The information is configured to indicate at least the subset of the one or more services, configured to be allowed in the communications system to the subscriber. The device is further configured to provide the information configured to be obtained to the endpoint of the data session with the device. The endpoint is configured to operate outside of the communications system.

According to a seventh aspect of embodiments herein, the object is achieved by the endpoint, for handling information in the communications system. The endpoint is configured to operate outside the communications system. The endpoint is further configured to obtain, from the device configured to operate in the communications system, the information. The information corresponds to the subscriber configured to be linked to the device. The information is configured to indicate the third node configured to operate in the communications system. The third node is further configured to have the capability to expose the one or more services configured to be available at the communications system. The information is configured to indicate at least the subset of the one or more services, configured to be allowed in the communications system to the subscriber. The endpoint is further configured to send the indication to the third node configured to be indicated in the information. The indication is configured to request the one of the one or more services in the subset.

According to an eighth aspect of embodiments herein, the object is achieved by the second node, for handling information in the communications system. The second node is configured to operate in the communications system. The second node is further configured to receive the request configured to identify the device. The second node is also configured to query the fourth node configured to operate in the communications system for information corresponding to the subscriber configured to be linked to the device. The second node is additionally configured to obtain the information from the fourth. The information is configured to indicate the third node configured to operate in the communications system. The third node is further configured to have the capability to expose the one or more services configured to be available at the communications system. The information is configured to indicate at least the subset of the one or more services, configured to be allowed in the communications system to the subscriber. The endpoint is further configured to provide the information configured to be obtained towards the device or to the first node configured to operate in the communications system.

According to an eighth aspect of embodiments herein, the object is achieved by the communications system, for handling information in the communications system. The communications system comprises the first node, the second node and the device. The communications system is further configured to obtain, by the first node, directly, or indirectly, from the second node configured to operate in the communications system, the information. The information corresponds to the subscriber configured to be linked to the device configured to operate in the communications system. The information is configured to indicate the third node configured to operate in the communications system. The third node is further configured to have the capability to expose the one or more services configured to be available at the communications system. The information is configured to indicate at least the subset of the one or more services, configured to be allowed in the communications system to the subscriber. The communications system is also configured to provide, by the first node, the information configured to be obtained towards the device. The communications system is further configured to obtain, by the device, the information directly, or indirectly, from the first node. The communications system is additionally configured to provide, by the device, the information configured to be obtained, to the endpoint of the data session with the device. The endpoint is configured to operate outside of the communications system. The communications system is also configured to obtain, by the endpoint, the information from the device configured to operate in the communications system. The information corresponds to the subscriber configured to be linked to the device. The communications system is also configured to send, by the endpoint, the indication to the third node configured to be indicated in the information. The indication is configured to request one of the one or more services in the subset.

By the second node receiving the request identifying the device, the second node may be enabled to query the fourth node and obtain the information from the fourth node. The second node may thereby be enabled to provide the information to the first node.

By obtaining the information, and the information indicating the third node and at least the subset of the one or more services allowed in the communications system to the subscriber, the first node may be enabled to know the third node that may correspond to the device, and which may therefore be able to handle application traffic for a particular device. The first node may then become enabled to provide this information to the device.

By providing the obtained information, the first node may enable the device to in turn provide the information to the endpoint of the data session with the device. The services provided by the operator the communications system may thereby be enabled to become discoverable and usable both by new applications, e.g., for which there may be no SLA in place, and by applications for which there may be an SLA in place. For examples wherein there may be no SLA in place, e.g., between the MNO and the content provider, the communications system may be enabled to advertise the available services towards the content provider and allow the content provider to start communicating via one or more application interfaces of the third node, e.g., Nnef APIs, to start getting network services. For examples wherein there may be an SLA in place, e.g., between the MNO and the content provider, the communications system may be enabled to share all the modifications to the configuration to use one or more application interfaces of the third node, e.g., the Nnef APIs. This may be understood to provide the flexibility to move the server hosting the APIs, and no hardcoded information may be needed. This may be understood to facilitate deployability and applicability of interfaces for the third node, e.g., NEF interfaces.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a 5G Network Architecture, non-roaming, according to existing methods.

FIG. 2 is a schematic diagram illustrating a non-limiting example of an CAPIF interfaces, according to existing methods.

FIG. 3 is a schematic diagram illustrating a non-limiting example of a client/server and proxy interaction, according to existing methods.

FIG. 4 is a schematic diagram illustrating a non-limiting example of a 5G Media Streaming architecture, according to existing methods.

FIG. 5 is a schematic diagram illustrating a non-limiting example of an analytics data collection from application client based on MNO AF, according to existing methods.

FIG. 6 is a schematic diagram illustrating a non-limiting example of a communications system, according to embodiments herein.

FIG. 7 is a flowchart depicting embodiments of a method in a first node, according to embodiments herein.

FIG. 8 is a flowchart depicting embodiments of a method in a device, according to embodiments herein.

FIG. 9 is a flowchart depicting embodiments of a method in an endpoint, according to embodiments herein.

FIG. 10 is a flowchart depicting embodiments of a method in a second node, according to embodiments herein.

FIG. 11 is a flowchart depicting embodiments of a method in a communications system, according to embodiments herein.

FIG. 12 is a schematic diagram depicting a non-limiting example of signalling between nodes in a communications system, according to embodiments herein.

FIG. 13 is a schematic diagram depicting a non-limiting example of signalling between nodes in a communications system, according to embodiments herein.

FIG. 14 is a schematic block diagram illustrating two non-limiting examples, a) and b), of a first node, according to embodiments herein.

FIG. 15 is a schematic block diagram illustrating two non-limiting examples, a) and b), of a device, according to embodiments herein.

FIG. 16 is a schematic block diagram illustrating two non-limiting examples, a) and b), of an endpoint, according to embodiments herein.

FIG. 17 is a schematic block diagram illustrating two non-limiting examples, a) and b), of a second node, according to embodiments herein.

FIG. 18 is a schematic block diagram illustrating two non-limiting examples, a) and b), of a communications system, according to embodiments herein.

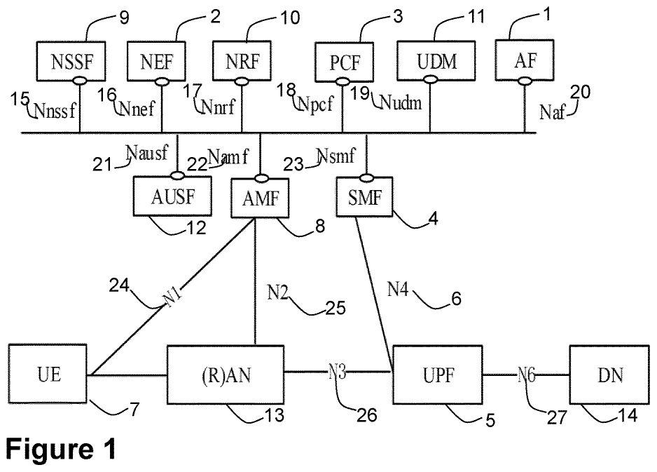

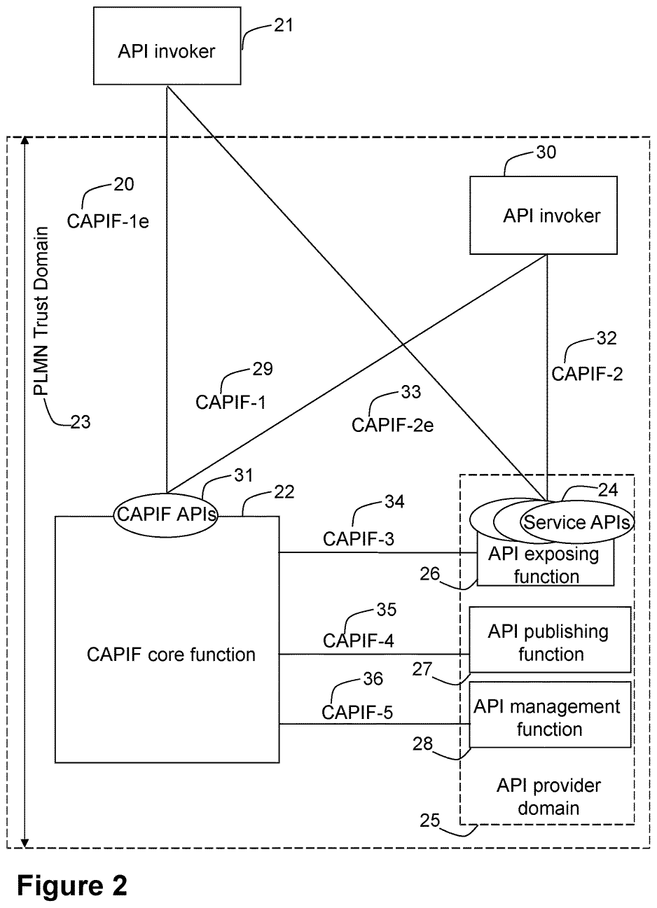

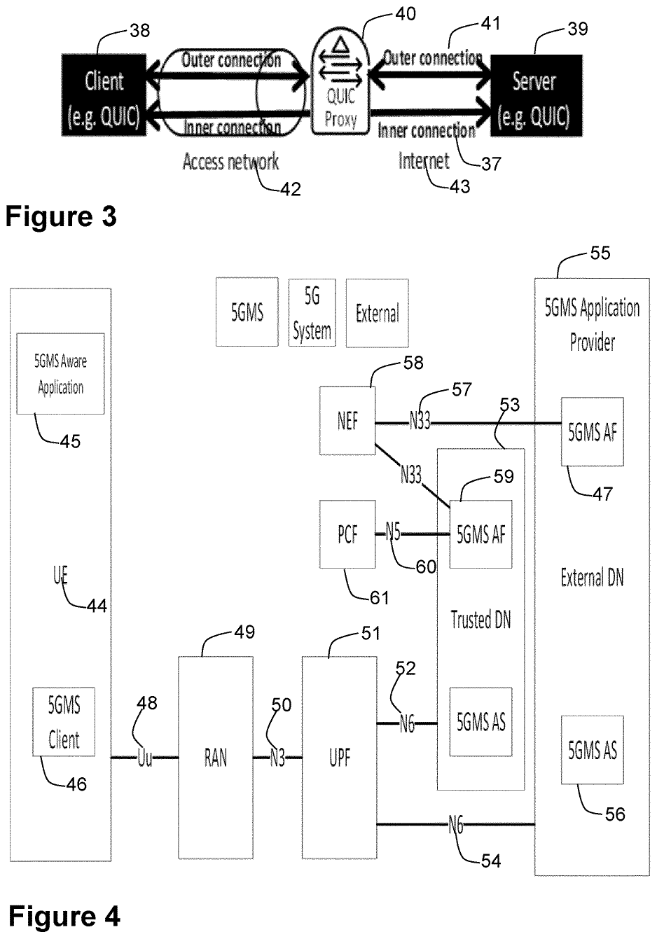

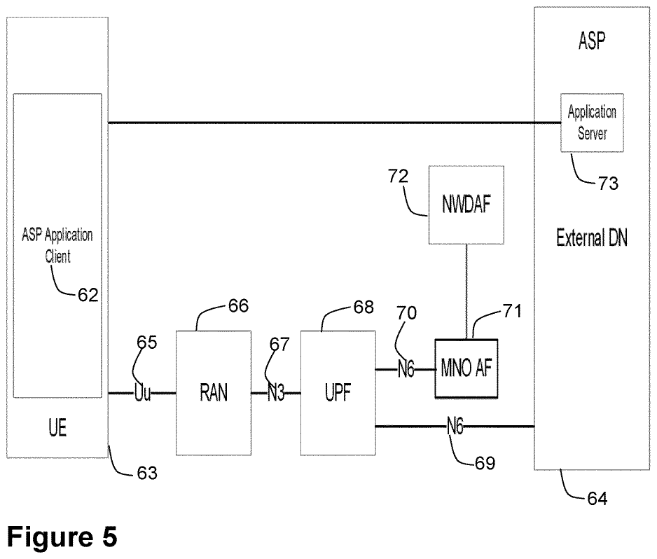

### DETAILED DESCRIPTION

Certain aspects of the present disclosure and their embodiments address one or more of the challenges identified with the existing methods and provide solutions to the challenges discussed.

Embodiments herein may relate to a method for bootstrapping, particularly, Nnef bootstrapping, using a client-network API. As a summarized overview, embodiments herein may be understood to provide a mechanism which may solve the problems described in the Summary section, and which may be based on using client-network APIs, e.g., COPE or ANIF, as a solution to discover an MNO's NEF and the MNO's NEF supported APIs for an application session of a subscriber.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

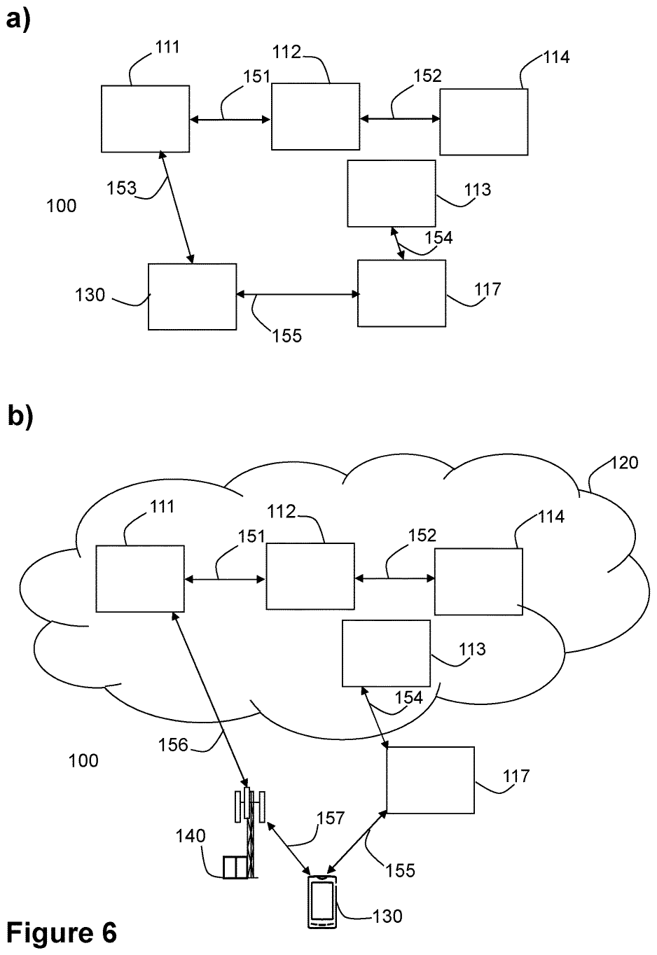

FIG. 6 depicts two non-limiting examples, in panels “a” and “b”, respectively, of a communications system 100, in which embodiments herein may be implemented. In some example implementations, such as that depicted in the non-limiting example of FIG. 6a, the communications system 100 may be a computer network. In other example implementations, such as that depicted in the non-limiting example of FIG. 6b, the communications system 100 may be implemented in a telecommunications system, sometimes also referred to as a telecommunications network, cellular radio system, cellular network or wireless communications system. In some examples, the telecommunications system may comprise network nodes which may serve receiving nodes, such as wireless devices, with serving beams.

In some examples, the telecommunications system may for example be a network such as a 5G system, or a newer system supporting similar functionality. In other examples, the telecommunications system may for example be a network such as such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band. The telecommunications system may also support other technologies, such as Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system. The telecommunications system may for example support a Low Power Wide Area Network (LPWAN). LPWAN technologies may comprise Long Range physical layer protocol (LoRa), Haystack, SigFox, LTE-M, and Narrow-Band IoT (NB-IoT).

The communications system 100 may comprise a plurality of nodes, and/or operate in communication with other nodes, whereof a first node 111, a second node 112, a third node 113, a fourth node 114, and another node 115, are depicted in FIG. 6. It may be understood that the communications system 100 may comprise more nodes than those represented on FIG. 6. For example, in some non-limiting examples, the communications system 100 may comprise a sixth node, which is not depicted in FIG. 6.

A further node may operate outside of the communications system 100, and may be an endpoint 117 of a data session with a device, such as the device 130 described below.

Any of the first node 111, the second node 112, the third node 113, the fourth node 114, the another node 115, the sixth node, and the endpoint 117 may be understood, respectively, as a first computer system, a second computer system, a third computer system, a fourth computer system, a fifth computer system, a sixth computer system and a seventh computer system. In some examples, any of the first node 111, the second node 112, the third node 113, the fourth node 114, the another node 115, the sixth node, and the endpoint 117 may be implemented as a standalone server in e.g., a host computer in the cloud 120, as depicted in the non-limiting example depicted in panel b) of FIG. 6. Any of the first node 111, the second node 112, the third node 113, the fourth node 114, the another node 115, the sixth node, and the endpoint 117 may in some examples be a distributed node or distributed server, with some of their respective functions being implemented locally, e.g., by a client manager, and some of its functions implemented in the cloud 120, by e.g., a server manager. Yet in other examples, any of the first node 111, the second node 112, the third node 113, the fourth node 114, the another node 115, the sixth node, and the endpoint 117 may also be implemented as processing resources in a server farm.

Any of the first node 111, the second node 112, the third node 113, the fourth node 114, the another node 115, the sixth node, and the endpoint 117 may be independent and separate nodes. Any of the first node 111, the second node 112, the third node 113, the fourth node 114, the another node 115 and the sixth node may be co-localized, or be the same node.

In some examples of embodiments herein, the first node 111 may be understood as a node that may have a capability to handle user plane traffic based on rules, according to embodiments herein. Non-limiting examples of the first node 111 wherein the communications system 100 may be a 5G network, may be i) a UPF, a Packet Data Network Gateway User plane function (PGW-U), or a Traffic Detection Function User plane (TDF-U), operating in the communications system 100, ii) an AF, or a Service Capability Server/Application Server (SCS/AS), operating in the communications system 100, and iii) SMF, a Packet Data Network Gateway Control plane function (PGW-C), or a Traffic Detection Function Control plane (TDF-C) operating in the communications system 100.

The second node 112 may be a node having a capability to support a unified policy framework to govern network behavior, according to embodiments herein. In particular examples wherein the communications system 100 may be a 5G network, the one or more second nodes 112 may be a Policy Charging Function, PCF, or a Policy and Charging Rule Function (PCRF), operating in the communications system 100.

The third node 113 may be a node having a capability to expose one or more services available at the communications system 100. In some particular examples wherein the communications system 100 may be a 5G network, the third node 113 may be a Network Exposure Function, NEF, of a Service Capability Exposure Function (SCEF), operating in the communications system 100.

The fourth node 114 may be a node having a capability to store data, e.g., grouped into distinct collections of subscription-related information, such as subscription data, policy data, structured data for exposure, and application data. In some particular examples wherein the communications system 100 may be a 5G network, the fourth node 114 may be a UDR.

The another node 115 may be a node having a capability to manage access of a device, such as e.g., the device 130 described below, to the communications system 100. In some particular examples wherein the communications system 100 may be a 5G network, the another node 115 may be an AMF.

The sixth node 116 may be a node having a capability to manage a session of a device, such as e.g., the device 130 described below, in the communications system 100, e.g., according to rules in the communications system 100. In some particular examples wherein the communications system 100 may be a 5G network, the sixth node 116 may be an SMF.

The endpoint 117 may be a node having a capability to interact with the a core network of the communications system 100 directly, or via the third node 113.

The communications system 100 may comprise a plurality of devices whereof a device 130 is depicted in FIG. 6. The device 130 may be also known as e.g., user equipment (UE), a wireless device, mobile terminal, wireless terminal and/or mobile station, mobile telephone, cellular telephone, or laptop with wireless capability, an Internet of Things (IoT) device, sensor, or a Customer Premises Equipment (CPE), just to mention some further examples. The device 130 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles, CPE or any other radio network unit capable of communicating over a radio link in the communications system 100. The device 130 may be wireless, i.e., it may be enabled to communicate wirelessly in the communications system 100 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications system 100.

The communications system 100 may comprise one or more radio network nodes, whereof a radio network node 140 is depicted in FIG. 6b. The radio network node 140 may typically be a base station or Transmission Point (TP), or any other network unit capable to serve a wireless device or a machine type node in the communications system 100. The radio network node 140 may be e.g., a 5G gNB, a 4G eNB, or a radio network node in an alternative 5G radio access technology, e.g., fixed or WiFi. The radio network node 140 may be e.g., a Wide Area Base Station, Medium Range Base Station, Local Area Base Station and Home Base Station, based on transmission power and thereby also coverage size. The radio network node 140 may be a stationary relay node or a mobile relay node. The radio network node 140 may support one or several communication technologies, and its name may depend on the technology and terminology used. The radio network node 140 may be directly connected to one or more networks and/or one or more core networks.

The communications system 100 covers a geographical area which may be divided into cell areas, wherein each cell area may be served by a radio network node, although, one radio network node may serve one or several cells.

The first node 111 may communicate with the second node 112 over a first link 151, e.g., a radio link or a wired link. The second node 112 may communicate with the fourth node 114 over a second link 152, e.g., a radio link or a wired link. The first node 111 may communicate, directly or indirectly with the device 130 over a third link 153, e.g., a radio link or a wired link. The third node 113 may communicate, directly or indirectly, with the endpoint 117 over a fourth link 154, e.g., a radio link or a wired link. The endpoint 117 may communicate, directly or indirectly, with the device 130 over a fifth link 155, e.g., a radio link or a wired link. The first node 111 may communicate, directly or indirectly with the radio network node 140 over a sixth link 156, e.g., a radio link or a wired link. The radio network node 140 may communicate with the device 130 over a seventh link 157, e.g., a radio link. Any of the respective first link 151, the second link 152, the third link 153, the fourth link 154, the fifth link 155 and/or the sixth link 156 may be a direct link or it may go via one or more computer systems or one or more core networks in the communications system 100, or it may go via an optional intermediate network. The intermediate network may be one of, or a combination of more than one of, a public, private or hosted network; the intermediate network, if any, may be a backbone network or the Internet, which is not shown in FIG. 6.

In general, the usage of “first”, “second”, “third”, “fourth”, “fifth”, “sixth” and/or “seventh” herein may be understood to be an arbitrary way to denote different elements or entities, and may be understood to not confer a cumulative or chronological character to the nouns these adjectives modify.

Although terminology from Long Term Evolution (LTE)/5G has been used in this disclosure to exemplify the embodiments herein, this should not be seen as limiting the scope of the embodiments herein to only the aforementioned system. Other wireless systems support similar or equivalent functionality may also benefit from exploiting the ideas covered within this disclosure. In future telecommunication networks, e.g., in the sixth generation (6G), the terms used herein may need to be reinterpreted in view of possible terminology changes in future technologies. For example, although the examples of embodiments herein may be described in the context of a 5G network architecture, the same mechanisms may be applied to a 4G network, just by replacing AF by SCS/AS, NEF by SCEF, UDR by Subscriber Profile Repository (SPR), PCF by PCRF, AMF by Mobility Management Entity (MME), SMF by PGW-C or TDF-C, and PGW-U by PGW-U or TDF-U.

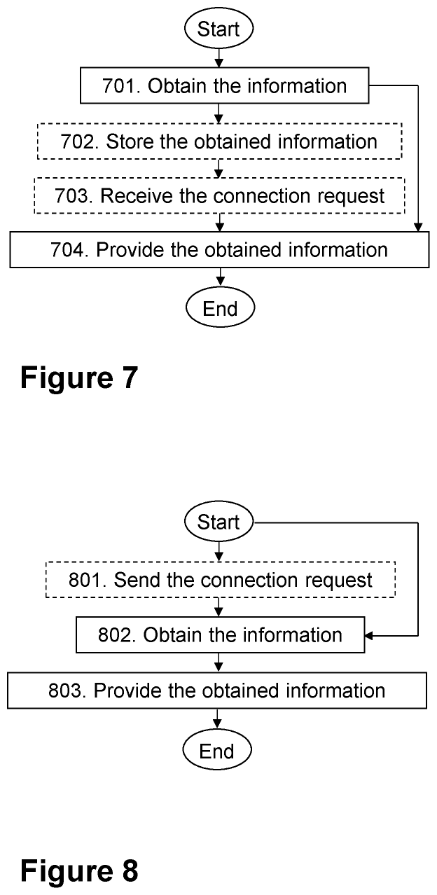

Embodiments of a computer-implemented method, performed by the first node 111, will now be described with reference to the flowchart depicted in FIG. 7. The method may be understood to be for handling information in the communications system 100. The first node 111 operates in the communications system 100.

Several embodiments are comprised herein. The method may comprise one or more of the following actions. In some embodiments, all the actions may be performed. In some embodiments, one or more actions may be performed. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. A non-limiting example of the method performed by the first wireless device 131 is depicted in FIG. 7.

In FIG. 7, optional actions are represented with dashed lines.

In some embodiments, at least one of the following may apply. The first node 111 may be one of: i) a UPF, a PGW-U, or a TDF-U operating in the communications system 100, ii) an AF, or a SCS/AS operating in the communications system 100, and iii) a SMF, a PGW-C, or a TDF-C operating in the communications system 100. The second node 112 may be a PCF, or a PCRF operating in the communications system 100. The third node 113 may be a NEF or a SCEF operating in the communications system 100. The device 130 may be a UE.

### Action 701

During the course of operations in the communications system 100, the communications system 100 may need to handle data for the device 130. For that purpose, one of the nodes in the communications system 100, e.g., the fifth node 115 in some examples, may receive a session establishment request, e.g., a PDU Session Establishment Request, from the device 130, identifying the device 130. The node in the communications system 100 that may receive such request, or that may subsequently handle data for such request, may then request subscriber information corresponding to the device 130. For example, the fifth node 115 may be an AMF which may, after receiving the PDU Session Establishment Request from the device 130, send an Nsmf_PDU_Session_Create_Request identifying the device 130 to the sixth node 116, which may be an SMF. The sixth node 116 may in turn send a request to create a policy control identifying the device 130 to the second node 112, which may be, for example, a PCF. This may be done by sending an Npcf_SMPolicyControl_Create_request. The second node 112 may then query the fourth node 114, e.g., a UDR, to retrieve subscriber information regarding a subscriber associated with the identified device 130. The second node 112 may do this by sending a Nudr_Query_Request identifying the device 130. The fourth node 114 may then look for the bootstrapping information in reference to the third node 113, as well as the allowed services for the identified device 130. The fourth node 114 may then return the requested subscriber information in a Nudr_Query_Response to the second node 112.

In this Action 701, the first node 111 may obtain, directly, or indirectly, from the second node 112 operating in the communications system 100, information corresponding to the subscriber linked to the device 130 operating in the communications system 100. The information indicates the third node 113 operating in the communications system 100. The third node 113 has a capability to expose one or more services available at the communications system 100. The information may further indicate at least a subset of the one or more services, allowed in the communications system 100 to the subscriber.

The obtaining, e.g., receiving, of the first indication may be performed e.g., via the first link 151.

The information may indicate at least one of: a) address information of the third node 113, and b) a list of the one or more services in the subset allowed to the subscriber, per respective application.

The address information of the third node 113 may be e.g., a Uniform Resource Identifier (URI), a Uniform Resource Locator (URL) or an Internet Protocol (IP) address which may allow to identify the third node 113. For example, the address information of the third node 113 may be, e.g., NEF address information. In such examples, this may be e.g., a URL or an IP address which may allow to identify the NEF. A content provider may then need to contact the third node 113 to retrieve more information about the offered network services.

The list of the one or more services in the subset allowed to the subscriber, per respective application may be, e.g., a list of (App-ID, allowed services). This may be understood to be a list of allowed services on a per application basis. For example, for App-ID=example.com, the following services may be allowed for the subscriber. One service may be, for example, a QoS service, e.g., a Nnef_AFsessionWithQoS service, so the content provider may be allowed to request a certain QoS for the application. Another service may be, a sponsoring service, e.g., Nnef_ChargeableParty service, so the application data may be allowed to be sponsored by a third party, e.g., content provider, so the application data may not be deducted from a subscriber's monthly quota.

In addition to the list of the one or more services in the subset that may be allowed to the subscriber, per respective application, the information may comprise, the following information encoded in some formatting such as JSON or CBOR or XML: MNO specific information and/or Subscriber specific information. The MNO specific information may comprise one or more of: MNO name, MNO Identifier and/or available services. The available services may comprise another list of services. The another list of services may further comprise name, id, and a short description. The subscriber specific information may comprise one or more of: MNO name, MNO Identifier, subscriber identifier, subscription details, allowed services, including the list of services and subscription status. The list of services may comprise name, id, and a short description. The subscription status may comprise different information such as the remaining monthly quota of the subscriber.

The MNO and/or subscriber specific information may be sent. For example, the MNO specific information may vary depending on if there is any SLA or not. And the subscriber specific information may not be sent if there is no SLA available.

Embodiments herein may be understood to be based on using client-network APIs, e.g., COPE or ANIF, as a way to discover the third node 113, e.g., NEF, of a particular MNO, and the APIs supported by the third node 113 of the MNO, for an application session of a subscriber of the device 130. This may be performed according to two different approaches in two different groups of embodiments. In a first group of embodiments, embodiments herein may use as a first alternative, bootstrapping of the third node 113 through COPE, e.g., Nnef bootstrapping through COPE. That is, COPE may be used to discover the third node 113 of the MNO, e.g., the MNO's NEF and the allowed APIs, e.g., services, of the third node 113 of the MNO, e.g., the MNO's NEF, for the application session of the subscriber. In the first group of embodiments, the first node 111 may be a QUIC Proxy at the UPF.

In a second group of embodiments, embodiments herein may use as a second alternative, bootstrapping of the third node 113 through ANIF, e.g., Nnef bootstrapping through ANIF. That is, ANIF may be used to discover the third node 113 of the MNO, e.g., the MNO's NEF and the allowed APIs, e.g., services, of the third node 113 of the MNO, e.g., the MNO's NEF, for the application session of the subscriber. In the second group of embodiments, the first node 111 may be a Mobile Network Operator Application Function (MNO AF).

In the first group of embodiments, that is for the bootstrapping of the third node 113, through COPE, following the example above, the second node 112 may have received the information from the fourth node 114, and then forwarded it to the sixth node 116, e.g., in a Npcf_SMPolicyControl_Create Response. The sixth node 116, may then forward the information to the first node 111 a PFCP Session Establishment reQuest, which may be then obtained by the first node 111 in this Action 701. A precondition of the embodiments in the first group of embodiments may be that the application client, e.g., App-ID=example.com, may support COPE.

In the second group of embodiments, that is for the bootstrapping of the third node 113, through ANIF, following the example above, the second node 112 may have received the information from the fourth node 114, and then forwarded it to the first node 111, e.g., in a Naf_Policy Request. A precondition of the embodiments in the second group of embodiments may be that the application client, e.g., App-ID=example.com, may support ANIF.

In either second group of embodiments, there may be also a number of further preconditions. A first further precondition may be that the list of CAPIF Core Function and instances of the third node 113, e.g., NEF instances may have been stored, e.g., by the MNO, at the fourth node 114, e.g., at the UDR. A second further precondition may be that the list of available APIs, e.g., services, instances of the third node 113 may have been stored, e.g., by the MNO, at the fourth node 114, e.g., at the UDR. A third further precondition may be that the list of allowed services both on a per application basis and subscriber basis may have been stored, e.g., by the MNO, at the fourth node 114, e.g., at the UDR, e.g., as subscriber data.

By obtaining the information in this Action 701, the first node 111 may be enabled to know the third node 113 that may correspond to the device 130, and which may therefore be able to handle application traffic for a particular device 130. The first node 111 may then become enabled to provide this information to the device 130 so that the device 130 may in turn provide it to the endpoint 117 of a data session with the device 130, which may operate outside of the communications system 100. The services provided by the operator the communications system 100 may thereby be enabled to become discoverable and usable both by new applications, e.g., for which there may be no SLA in place, and by applications for which there may be an SLA in place. This may be understood to facilitate deployability and applicability of interfaces for the third node 113, e.g., NEF interfaces.

### Action 702

In this Action 702, the first node 111 may store the obtained information in a storage.

By storing the obtained information in this Action 702, the first node 111 may be enabled to later retrieve it upon request by the device 130.

### Action 703

In this Action 703, the first node 111 may receive a connection request from the device 130.

The receiving of the connection request may be performed e.g., via the third link 153, or via the sixth link 156 and the seventh link 157.

This Action 703 may be performed, for example, after the session for the device 130 may have been established. At some point, the device 130 may open an application, e.g., example.com, and an application client may then open a connection with the first node 111 by sending a connection request.

In the first group of embodiments, the application client may do this by, for example, using QUIC as a transport protocol. The application client, which in these examples may support COPE, may create an outer QUIC connection with the first node 111, e.g., a QUIC proxy, as for example, an Outer QUIC connection request. The connection request may include an indentifier for the device 130, e.g., UE-ID, an identifier for the for the application, e.g., App-ID=example.com, and an indication to request service information.

In the second group of embodiments, the application client may open a connection with the first node 111, e. g, an MNO AF, by, for example sending an Application client connection setup to the first node 111. The connection setup may include the indentifier for the device 130, e.g., UE-ID, the identifier for the for the application, e.g., App-ID=example.com, and the indication to request service information.

### Action 704

In this Action 704, the first node 111 provides the obtained information towards the device 130.

The obtained information may be retrieved from the storage and provided to the device 130 in response to the received connection request. For example, the first node 111 may answer with the stored information in Action 702 for the identified device 130, e.g., for the corresponding UE-ID, and for the identified application, e.g., App-ID, here, example.com. The obtained information may include: the NEF address information and the allowed services for the identified application, e.g., App-ID, here, example.com. The allowed services may be, e.g. Nnef_ChargeableParty service and Nnef_AFsessionWithQoS service. This may apply to either group of embodiments described above.

The providing, e.g., sending, in this Action 704 may be performed e.g., via the third link 153, or via the sixth link 156 and the seventh link 157.

By providing the obtained information in this Action 704, the first node 111 may enable the device 130 to in turn provide the information to the endpoint 117 of a data session with the device 130, which endpoint 117 may operate outside of the communications system 100. The services provided by the operator the communications system 100 may thereby be enabled to become discoverable and usable both by new applications, e.g., for which there may be no SLA in place, and by applications for which there may be an SLA in place. For examples wherein there may be no SLA in place, e.g., between the MNO and the content provider, the communications system 100 may be enabled to advertise the available services towards the content provider and allow the content provider to start communicating via one or more application interfaces of the third node 113, e.g., Nnef APIs, to start getting network services. For examples wherein there may be an SLA in place, e.g., between the MNO and the content provider, the communications system 100 may be enabled to share all the modifications to the configuration to use one or more application interfaces of the third node 113, e.g., the Nnef APIs. This may be understood to provide the flexibility to move the server hosting the APIs, and no hardcoded information may be needed. This may be understood to facilitate deployability and applicability of interfaces for the third node 113, e.g., NEF interfaces.

Embodiments of a computer-implemented method performed by the device 130, will now be described with reference to the flowchart depicted in FIG. 8. The method may be understood to be for handling information in the communications system 100. The device 130 operates in the communications system 100.

The method may comprise the following actions. Several embodiments are comprised herein. In some embodiments, the method may comprise all actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 8, optional actions are depicted with dashed lines.

The detailed description of some of the following corresponds to the same references provided above, in relation to the actions described for the first node 111 and will thus not be repeated here to simplify the description. For example, the address information of the third node 113 may be e.g., a URL or an IP address which may allow to identify the third node 113. Also, in some embodiments, at least one of the following may apply. The first node 111 may be one of: i) a UPF, a PGW-U, or a TDF-U operating in the communications system 100, ii) an AF, or a SCS/AS operating in the communications system 100, and iii) a SMF, a PGW-C, or a TDF-C operating in the communications system 100. The second node 112 may be a PCF, or a PCRF operating in the communications system 100. The third node 113 may be a NEF or a SCEF operating in the communications system 100. The endpoint 117 may be another AS, or another AF. The device 130 may be a UE.

### Action 801

In this Action 801, the device 130 may send the connection request to the first node 111. The information may be obtained in response to the sent connection request.

The sending of the connection request may be performed e.g., via the third link 153, or via the sixth link 156 and the seventh link 157.

At some point, the device 130 may open an application, e.g., example.com, and the application client may then open a connection with the first node 111 by sending the connection request.

In the first group of embodiments, the application client may do this by, for example, using QUIC as a transport protocol. The application client, which in these examples may support COPE, may create an outer QUIC connection with the first node 111, e.g., a QUIC proxy, as for example, an Outer QUIC connection request. The connection request may include an indentifier for the device 130, e.g., UE-ID, an identifier for the for the application, e.g., App-ID=example.com, and an indication to request service information.

In the second group of embodiments, the application client may open a connection with the first node 111, e. g, an MNO AF, by, for example sending an Application client connection setup to the first node 111. The connection setup may include the indentifier for the device 130, e.g., UE-ID, the identifier for the for the application, e.g., App-ID=example.com, and the indication to request service information.

Accordingly, in some embodiments, the connection request may indicate a first application and the information may indicate at least one of: a) the address information of the third node 113, and b) the first list of the one or more services comprised in the subset. The one or more services may be allowed to the subscriber for the indicated first application.

The obtained information may be further based on the request to establish the session having been sent by the device 130 to the another node 115 operating in the communications system 100. For example, the UE may have originally triggered a PDU Session Establishment procedure.

### Action 802

In this Action 802, the device 130 obtains, directly, or indirectly, from the first node 111 operating in the communications system 100, the information corresponding to the subscriber linked to the device 130. The information indicates the third node 113 operating in the communications system 100 having the capability to expose the one or more services available at the communications system 100. The information also indicates at least the subset of the one or more services, allowed in the communications system 100 to the subscriber.

The obtaining, e.g., receiving, in this Action 802 may be performed e.g., via the third link 153, or via the sixth link 156 and the seventh link 157.

### Action 803

In this Action 803, the device 130 provides the obtained information to the endpoint 117 of a data session with the device 130. The endpoint 117 operates outside of the communications system 100. For example, the application client, e.g., example.com, may forward the information received in Action 802 to the endpoint 117, e.g., the application server.

By, in this Action 803, providing the information to the endpoint 117, which endpoint 117 may operate outside of the communications system 100, the services provided by the operator the communications system 100 may thereby be enabled to become discoverable and usable both by new applications, e.g., for which there may be no SLA in place, and by applications for which there may be an SLA in place. For examples wherein there may be no SLA in place, e.g., between the MNO and the content provider, the communications system 100 may be enabled to advertise the available services towards the content provider and allow the content provider to start communicating via one or more application interfaces of the third node 113, e.g., Nnef APIs, to start getting network services. For examples wherein there may be an SLA in place, e.g., between the MNO and the content provider, the communications system 100 may be enabled to share all the modifications to the configuration to use one or more application interfaces of the third node 113, e.g., the Nnef APIs. This may be understood to provide the flexibility to move the server hosting the APIs, and no hardcoded information may be needed. This may be understood to facilitate deployability and applicability of interfaces for the third node 113, e.g., NEF interfaces.

The providing, e.g., sending, in this Action 803 may be performed e.g., via the fifth link 155.

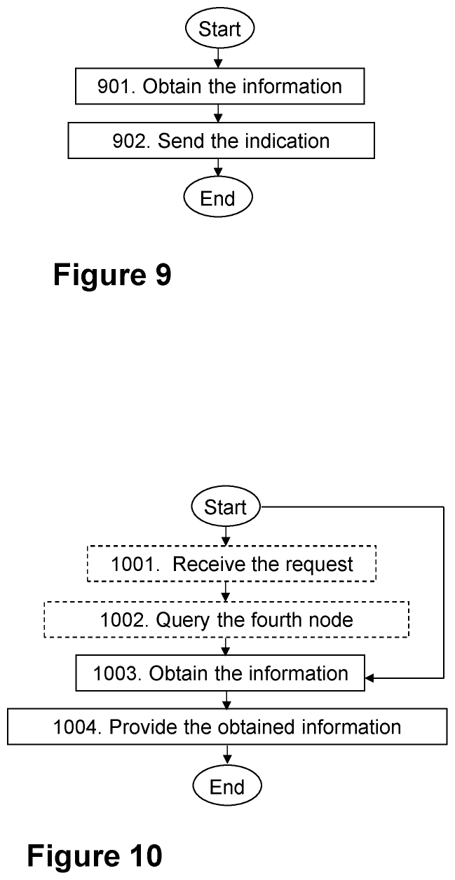

Embodiments of a computer-implemented method performed by the endpoint 117, will now be described with reference to the flowchart depicted in FIG. 9. The method may be understood to be for handling information in the communications system 100. The endpoint 117 operates outside the communications system 100.

The method may comprise the following actions. Several embodiments are comprised herein. In some embodiments, the method may comprise all actions. In other embodiments, the method may comprise two or more actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 9, optional actions are depicted with dashed lines.

The detailed description of some of the following corresponds to the same references provided above, in relation to the actions described for the first node 111 and will thus not be repeated here to simplify the description. For example, the address information of the third node 113 may be e.g., a URL or an IP address which may allow to identify the third node 113. Also, in some embodiments, at least one of the following may apply. The third node 113 may be a NEF or a SCEF operating in the communications system 100. The endpoint 117 may be another AS, or another AF. The device 130 may be a UE.

### Action 901

In this Action 901, the endpoint 117 obtains, from the device 130 operating in the communications system 100, the information corresponding to the subscriber linked to the device 130. The information indicates the third node 113 operating in the communications system 100 having the capability to expose the one or more services available at the communications system 100. The information also indicates at least the subset of the one or more services allowed in the communications system 100 to the subscriber.

The obtaining, e.g., receiving, in this Action 901 may be performed e.g., via the fifth link 155.

The information may indicate at least one of: a) the address information of the third node 113, and b) a first list of the one or more services comprised in the subset, the one or more services being allowed for the first application indicated by the device 130.

Based on the obtained information, the endpoint 117, e.g., an AS, may decide to sponsor application data for the user application session.

By the endpoint 117 obtaining the information from the device 130 in this Action 901, the content provider may be allowed to start communicating via one or more application interfaces of the third node 113, e.g., Nnef APIs, to start getting network services. For examples wherein there may be an SLA in place, e.g., between the MNO and the content provider, the communications system 100 may be enabled to share all the modifications to the configuration to use one or more application interfaces of the third node 113, e.g., the Nnef APIs. This may be understood to provide the flexibility to move the server hosting the APIs, and no hardcoded information may be needed. This may be understood to facilitate deployability and applicability of interfaces for the third node 113, e.g., NEF interfaces.

### Action 902

The endpoint 117, e.g., the AS, through an AF, may use the address information to identify the instance of the third node 113. In this Action 902, the endpoint 117 sends an indication to the third node 113 indicated in the information. The indication requests one of the one or more services in the subset. The indication may be an API service request to sponsor application traffic through Nnef_ChargeableParty service.

The sending in this Action 902 may be performed e.g., via the fourth link 154.

The indication may include the following information an identifier of the application function, e.g., AF-ID, the identifier of the application, e.g., App-ID=example.com, and an identifier of the service, e.g., service=Nnef_ChargeableParty. The third node 113 may then authorize the request and apply the corresponding actions. For example, the third node 113 may trigger towards the second node 112, a request to sponsor traffic for the subscriber's application session.

Embodiments of a computer-implemented method performed by the second node 112, will now be described with reference to the flowchart depicted in FIG. 10. The method may be understood to be for handling information in the communications system 100. The second node 112 operates in the communications system 100.

The method may comprise the following actions. Several embodiments are comprised herein. In some embodiments, the method may comprise all actions. In other embodiments, the method may comprise some actions. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 10, optional actions are depicted with dashed lines.

The detailed description of some of the following corresponds to the same references provided above, in relation to the actions described for the first node 111 and will thus not be repeated here to simplify the description. For example, the address information of the third node 113 may be e.g., a URL or an IP address which may allow to identify the third node 113. Also, in some embodiments, at least one of the following may apply. The first node 111 may be one of: i) a UPF, a PGW-U, or a TDF-U operating in the communications system 100, ii) an AF, or a SCS/AS operating in the communications system 100, and iii) a SMF, a PGW-C, or a TDF-C operating in the communications system 100. The second node 112 may be a PCF, or a PCRF operating in the communications system 100. The third node 113 may be a NEF or a SCEF operating in the communications system 100. The the fourth node 114 may be a UDR, or a Subscriber Profile Repository (SPR) operating in the communications system 100. The second node 112 may be a UE.

### Action 1001

In this Action 1001, the second node 112 receives a request identifying the device 130.

The second node 112 may receive the request from the sixth node 116, as the request to create a policy control. This may be done by receiving the Npcf_SMPolicyControl_Create_request.

The receiving in this Action 1001 may be performed e.g., via a respective link between the second node 112 and the sixth link 116.

### Action 1002

In this Action 1002, the second node 112 queries the fourth node 114 operating in the communications system 100 for the information corresponding to the subscriber linked to the device 130. The second node 112 may do this by sending a Nudr_Query_Request identifying the device 130. The fourth node 114 may then look for the bootstrapping information in reference to the third node 113, as well as the allowed services for the identified device 130.

The querying, in this Action 1002 may be performed e.g., via the second link 152.

### Action 1003

In this Action 1003, the second node 112 obtains the information from the fourth node 114. The information indicates the third node 113 operating in the communications system 100. The third node 113 has the capability to expose the one or more services available at the communications system 100. The information may further indicate at least the subset of the one or more services, allowed in the communications system 100 to the subscriber.

The obtaining, e.g., receiving, of the first indication may be performed e.g., via the second link 152.

In some examples wherein the second node 112 may be a PCF, and the fourth node 114 may be a UDR, the PCF may retrieve from UDR the session and subscriber data for UE-ID, which may be extended with the following parameters according to embodiments herein. First, NEF address information. This may be e.g. the URL or the IP address which may allow to identify the NEF. Second, the list of App-ID, allowed services. This may be understood to be the list of allowed services on a per application basis. For example, for App-ID=example.com, the following services may be allowed for the subscriber. As a first service, the QoS service, e.g., Nnef_AFsessionWithQoS service, so the content provider may be allowed to request a certain QoS for the application.. The second node 112 may for example obtain the requested subscriber information in a Nudr_Query_Response from the fourth node 114. As a second service, the sponsoring service, e.g., Nnef_ChargeableParty service, so the application data may be allowed to be sponsored by a third party, e.g., content provider, so it may not be deducted from the monthly quota of the subscriber.

The information may indicate at least one of: a) the address information of the third node 113, and b) the list of the one or more services in the subset allowed to the subscriber, per respective application.

### Action 1004

In this Action 1004, the second node 112 provides the obtained information towards the device 130 or to the first node 111 operating in the communications system 100.

The providing, e.g., sending, in this Action 1003 may be performed e.g., via the first link 151, the third link 153, and/or the sixth link 156 and the seventh link 157.

In some examples wherein the second node 112 may be a PCF, the PCF may forward to the sixth node 116, e.g., the SMF, the information retrieved in Action 1004. The N7 interface may be extended, e.g., by extending the PCC rule to include the allowed services on a per application basis.

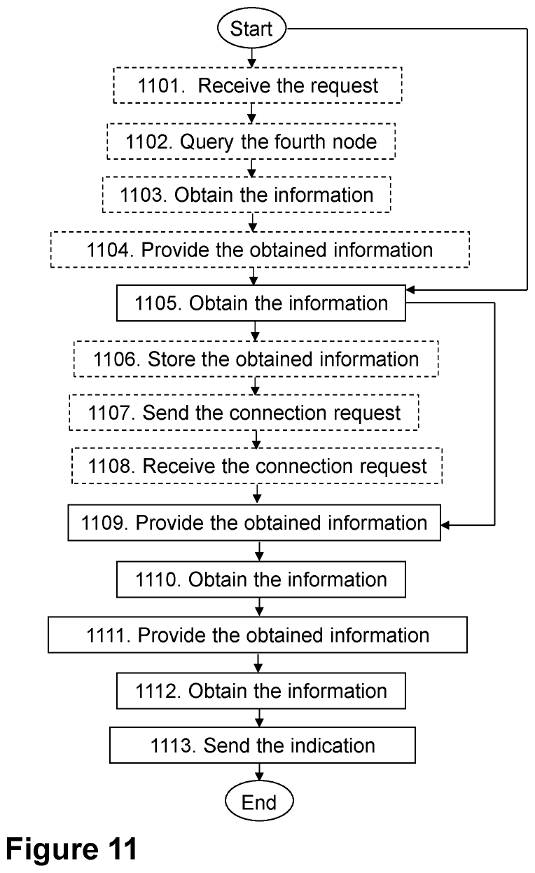

Embodiments of a computer-implemented method, performed by the communications system 100, will now be described with reference to the flowchart depicted in FIG. 11. The method may be understood to be for handling information in the communications system 100. The communications system 100 comprises the first node 111, the second node 112 and the device 130.

The method may comprise the actions described below. In some embodiments some of the actions may be performed. In some embodiments all the actions may be performed. In FIG. 11, optional actions are indicated with a dashed box. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

The detailed description of some of the following corresponds to the same references provided above, in relation to the actions described for the first node 111 and will thus not be repeated here to simplify the description. For example, the address information of the third node 113 may be e.g., a URL or an IP address which may allow to identify the third node 113. Also, in some embodiments, at least one of the following may apply. The first node 111 may be one of: i) a UPF, a PGW-U, or a TDF-U operating in the communications system 100, ii) an AF, or a SCS/AS operating in the communications system 100, and iii) a SMF, a PGW-C, or a TDF-C operating in the communications system 100. The second node 112 may be a PCF, or a PCRF operating in the communications system 100. The third node 113 may be a NEF or a SCEF operating in the communications system 100. The second node 112 may be a UE.

### Action 1101

In some embodiments, the method may comprise, in this Action 1101, which corresponds to Action 1001, receiving, by the second node 112, the request identifying the device 130.

### Action 1102

In some embodiments, the method may comprise, in this Action 1102, which corresponds to Action 1002, querying, by the second node 112, the fourth node 114 operating in the communications system 100 for the information corresponding to the subscriber linked to the device 130.

The the fourth node 114 may be a UDR, or a Subscriber Profile Repository (SPR) operating in the communications system 100.

### Action 1103

In some embodiments, the method may comprise, in this Action 1103, which corresponds to Action 1003, obtaining, by the second node 112, the information from the fourth node 114.

The information indicates the third node 113 operating in the communications system 100. The third node 113 has the capability to expose the one or more services available at the communications system 100. The information may further indicate at least the subset of the one or more services, allowed in the communications system 100 to the subscriber.

The information may indicate at least one of: a) the address information of the third node 113, and b) the list of the one or more services in the subset allowed to the subscriber, per respective application.

### Action 1104

In some embodiments, the method may comprise, in this Action 1104, which corresponds to Action 1004, providing, by the second node 112, the obtained information towards the device 130 or to the first node 111 operating in the communications system 100.

### Action 1105

This Action 1105, which corresponds to Action 701, comprises, obtaining 1105, by the first node 111, directly, or indirectly, from the second node 112 operating in the communications system 100, the information corresponding to the subscriber linked to the device 130 operating in the communications system 100. The information indicates the third node 113 operating in the communications system 100. The third node 113 has the capability to expose one or more services available at the communications system 100. The information may further indicate at least the subset of the one or more services, allowed in the communications system 100 to the subscriber.

The information may indicate at least one of: a) the address information of the third node 113, and b) the list of the one or more services in the subset allowed to the subscriber, per respective application.

### Action 1106

In some embodiments, the method may comprise, in Action 1106, which corresponds to Action 702, storing, by the first node 111, the obtained information in the storage.

### Action 1107

In some embodiments, the method may comprise, in this Action 1107, which corresponds to Action 801, sending, by the device 130, the connection request to the first node 111. The information may be obtained in response to the sent connection request.

### Action 1108

This Action 1108, which corresponds to Action 703, comprises receiving 1108, by the first node 111, the connection request from the device 130.

### Action 1109

This Action 1109, which corresponds to Action 704, comprises, providing, by the first node 111, the obtained information towards the device 130.

The obtained information may be retrieved from the storage and provided to the device 130 in response to the received connection request.

In some embodiments, the connection request may indicate the first application and the information may indicate at least one of: a) the address information of the third node 113, and b) the first list of the one or more services comprised in the subset. The one or more services may be allowed to the subscriber for the indicated first application.

The obtained information may be further based on the request to establish the session having been sent by the device 130 to the another node 115 operating in the communications system 100

### Action 1110

This Action 1110, which corresponds to Action 802, comprises obtaining, by the device 130, the information directly, or indirectly, from the first node 111.

### Action 1111

This Action 1111, which corresponds to Action 803, comprises, providing, by the device 130, the obtained information to the endpoint 117 of the data session with the device 130. The endpoint 117 operates outside of the communications system 100.

### Action 1112

This Action 1112, which corresponds to Action 901, comprises, obtaining, by the endpoint 117, the information from the device 130 operating in the communications system 100, the information corresponding to the subscriber linked to the device 130.

### Action 1113

This Action 1113, which corresponds to Action 902, comprises, sending, by the endpoint 117, the indication to the third node 113 indicated in the information. The indication requests one of the one or more services in the subset.

Two non-limiting examples of a method in the communications system 100 according to embodiments herein will now be described in the next two Figures.

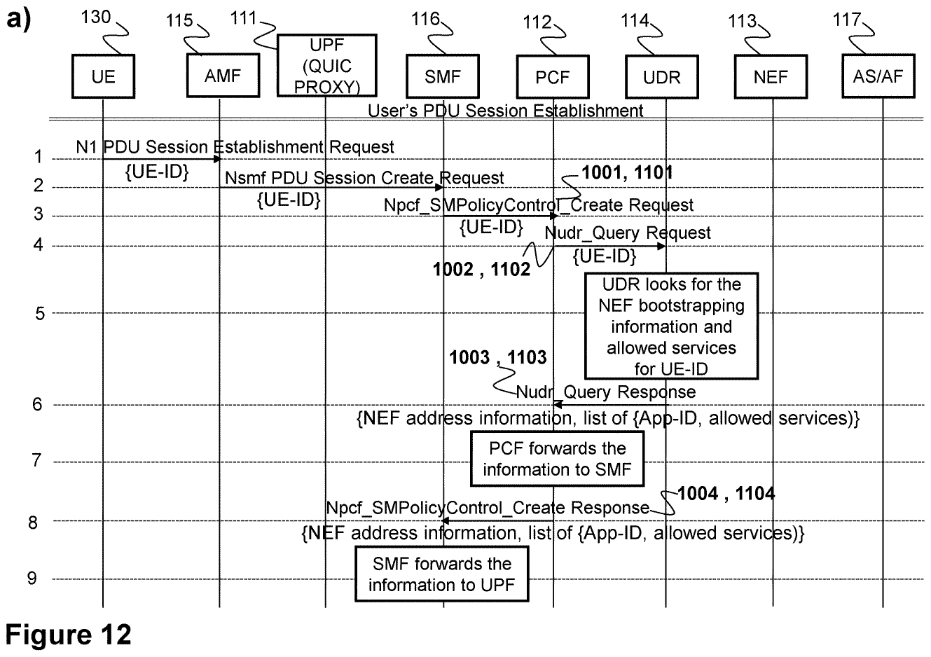

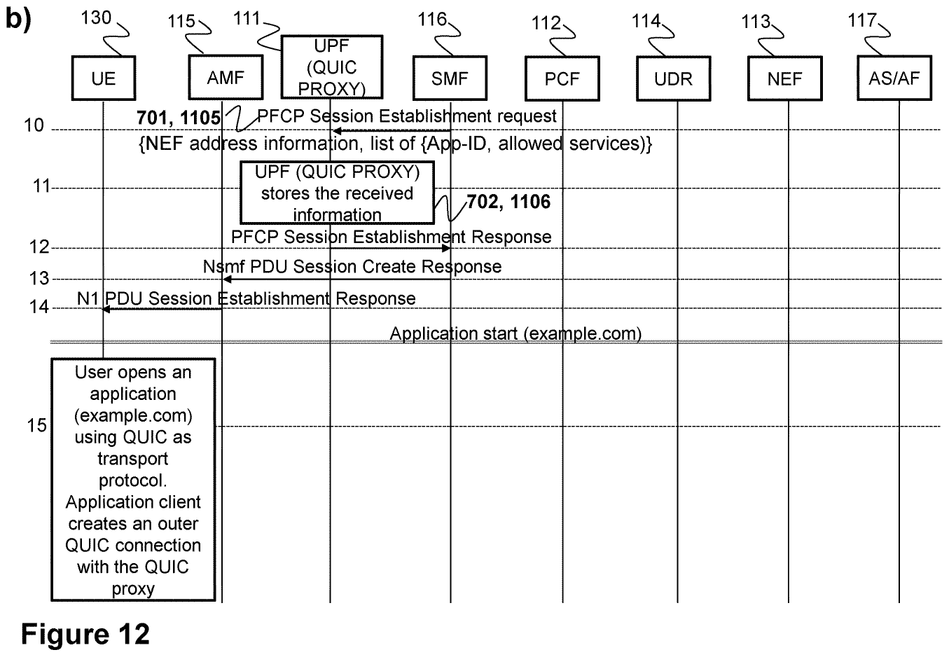

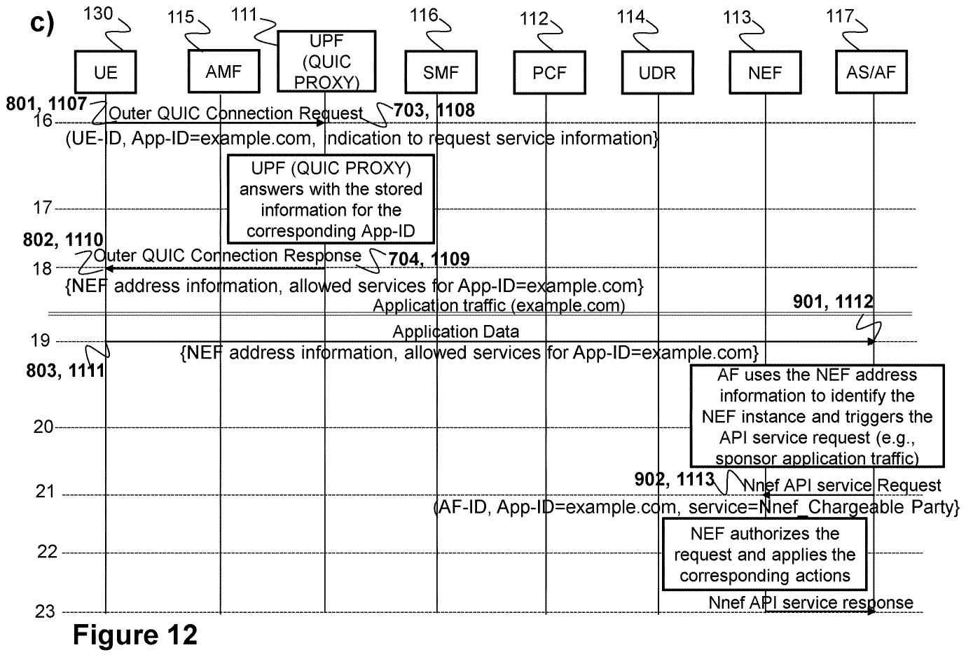

FIG. 12 is a signalling diagram depicting a non-limiting example of a method performed in the communications system 100, according to embodiments herein, over panels a), b) and c). Panel b) is a continuation of panel a) and panel c) is a continuation of panel b). FIG. 12 depicts a non-limiting example of the first group of embodiments, particularly of Nnef bootstrapping through COPE. The sequence diagram is shown in FIG. 12 and shows an example where COPE is used to discover MNO's NEF and the MNO's NEF allowed APIs (services) for the subscriber's application session. The method of FIG. 12 may have as preconditions that, first, the MNO may have stored the list of CAPIF Core Function and NEF instances. It may be assumed this information is stored in UDR. Second, that the MNO may have stored the list of available NEF APIs (services) instances. It may be assumed this information is stored in UDR. Third, that the MNO may have stored the list of allowed services both on a per application basis and subscriber basis. It may be assumed this is stored in UDR, as subscriber data. And fourth, that the application client, e.g., App-ID=example.com, may support COPE. In FIG. 12, the first node 111 is a UPF, a QUIC proxy, the second node 112 is a PCF, the third node 113 is an NEF, the fourth node 114 is a UDR, the fifth node 115 is an AMF, the sixth node 116 is an SMF, the seventh node 117 is an AS/AF, the device 130 is a UE, and the endpoint 117 is an AS/AF. In Step 1, the device 130, triggers a PDU Session Establishment procedure. For simplicity reasons, not all steps are shown. Particularly, the device 130 sends an N1 PDU Session Establishment request to the fifth node 115. In Step 2, the fifth node 115 sends an Nsmf PDU Session Create Request the sixth node 116, including the identifier of the device 130 as a UE-ID. In Step 3, the sixth node 116 sends the request identifying a device 130 to the second node 112, as an Npcf_SMPolicyControl_Create Request, including the identifier of the device 130 as the UE-ID. The second node 112 receives the request in accordance with Action 1001 and Action 1101. In Step 4, the second node 112, in accordance with Action 1002 and Action 1102, queries the fourth node 114 for the information corresponding to the subscriber linked to the device 130. The second node 112 does this by sending a Nudr_Query Request to the fourth node 114 including the identifier of the device 130 as a UE-ID. In Step 5, the fourth node 114 looks for the NEF bootstrapping information and allowed services for the UE-ID. In step 6, in accordance with Action 1003 and Action 1103, the second node 112 retrieves from the UDR the session and subscriber data for UE-ID, which is extended with the following parameters: a) the NEF address information, which may be e.g., the URL or the IP address which may allow to identify the NEF and b) the list of (App-ID, allowed services). This may be understood to be the list of allowed services on a per application basis. For example, for App-ID=example.com, the following services may be allowed for the subscriber: i) QoS service (Nnef_AFsessionWithQoS service), so the content provider may be allowed to request a certain QoS for the application, and ii) sponsoring service, e.g., Nnef_ChargeableParty service, so the application data may be allowed to be sponsored by a third party, e.g., content provider, so it may not be deducted from the subscriber's monthly quota. The second node 112 may retrieve the information by receiving a Nudr_Query Response comprising {NEF address information, list of {App-ID, allowed services)}. In Step 7 and Step 8, in accordance with Action 1004 and Action 1104, the second node 112 may then forward the information to the sixth node 116. This may be done by sending a Npcf_SMPolicyControl_Create Response comprising the {NEF address information, list of {App-ID, allowed services)}. In embodiments herein, the N7 interface may be extended, e.g., by extending the PCC rule to include the allowed services on a per application basis. In Step 9 and Step 10, the sixth node 116 triggers a PFCP Session Establishment procedure and forwards to the first node 111 the information retrieved in step 8 above. In embodiments herein, the N4 interface may be extended, e.g., by extending the PDR/FAR/QER/URR to include the allowed services on a per application basis. The sixth node 116 may do this by sending a PFCP Session Establishment reQuest comprising the {NEF address information, list of {App-ID, allowed services)}. This is received by the first node 111 in accordance with Action 701 and Action 1105. In Step 11, the UPF forwards to the QUIC Proxy, e.g., acting as an embedded SF, the information retrieved in step 10 above. Then, in accordance with Action 702 and Action 1106, the QUIC Proxy stores the received information. In Step 12, the UPF answers the sixth node 116 with a PFCP Session Establishment Response message indicating successful operation. In Step 13, the sixth node 116 answers the message in Step 2 by triggering a Nsmf PDU Session Create Response message. In Step 14, the fifth node 115 answers the message in Step 1 by triggering a N1 PDU Session Establishment Response message. In Steps 15 and 16, the device 130 opens an application, e.g., example.com, using QUIC as transport protocol. The application client, which supports COPE, in accordance with Action 801 and Action 1107, creates an outer QUIC connection with the QUIC proxy and includes the following information: UE-ID, App-ID=example.com and the indication to request service information. The first node 111 receives this in accordance with Action 703 and Action 1108. In Steps 17 and 18, the first node 111, the QUIC Proxy, in accordance with Action 704 and Action 1109, answers with the stored information, at step 11 above, for the corresponding UE-ID and App-ID (example.com), including: the NEF address information, and the allowed services for App-ID=example.com, e.g., Nnef_ChargeableParty service and Nnef_AFsessionWithQoS service. The device 130 receives the information in accordance with Action 802 and Action 1110. In Step 19, the application client (example.com), in accordance with Action 803 and Action 1111, forwards the information received in step 18 to the endpoint 117. The endpoint 117 receives the information in accordance with Action 901 and Action 1112. In Step 20, the endpoint 117, based on the received information, decides to sponsor application data for the user application session. In Step 21, the endpoint 117, that is, the AS through an AF, uses the NEF address information to identify the NEF instance and triggers, in accordance with Action 902 and Action 1113, the API service request to sponsor application traffic through Nnef_ChargeableParty service, by sending an Nnef API service Request including the following information: the AF-ID, the App-ID=example.com, and the service=Nnef_ChargeableParty. In Steps 22 and 23, the third node 113 authorizes the request and applies the corresponding actions. In this example, the NEF will trigger towards the PCF a request to sponsor traffic for the subscriber's application session. This is not shown in the sequence diagram of FIG. 12 as it is based on existing procedures. The third node 113 also sends a Nnef API service response back to the endpoint 117 in Step 23.

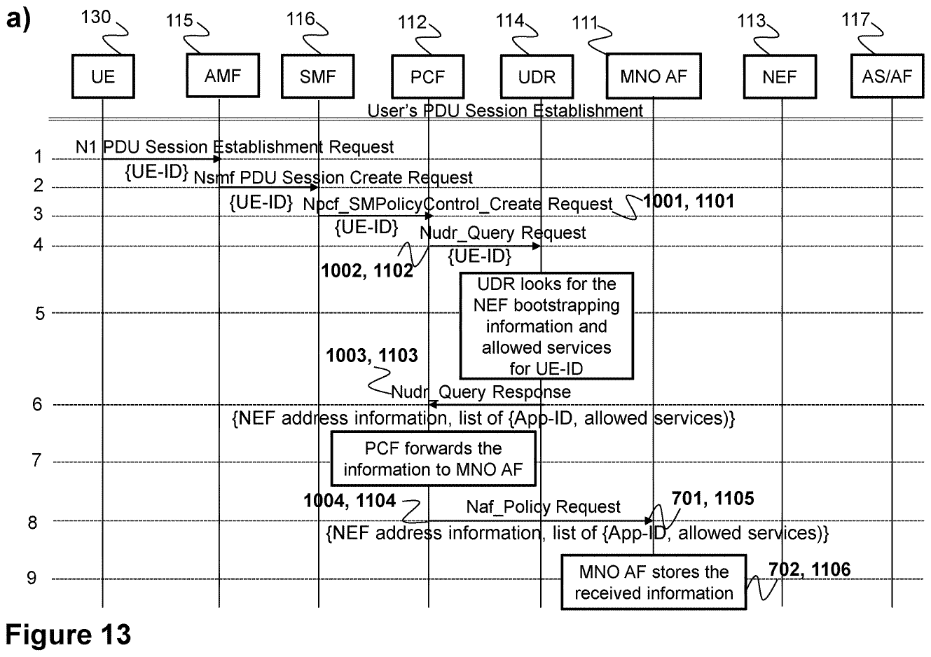

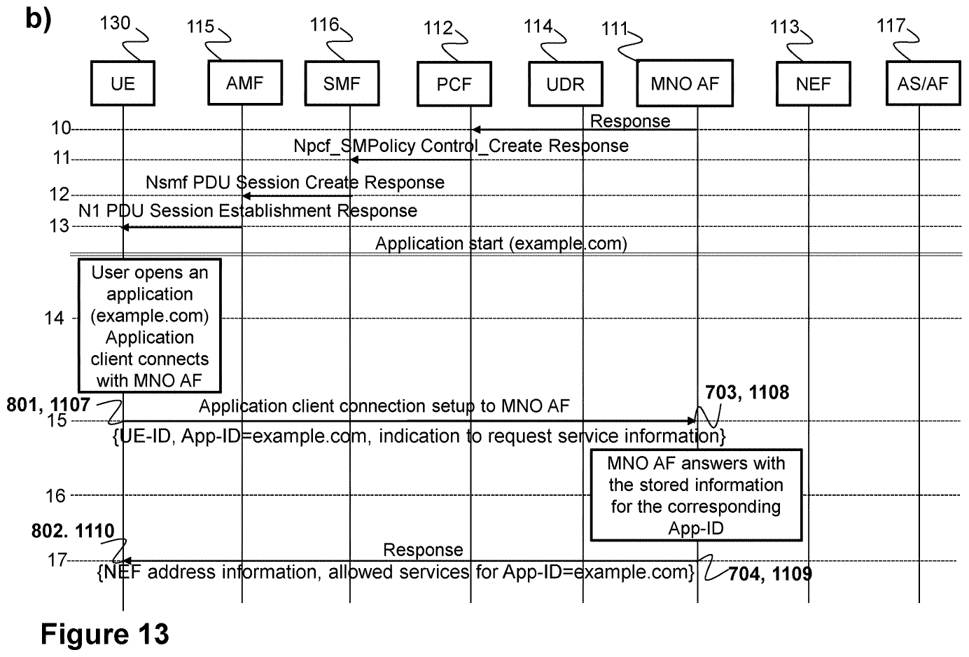

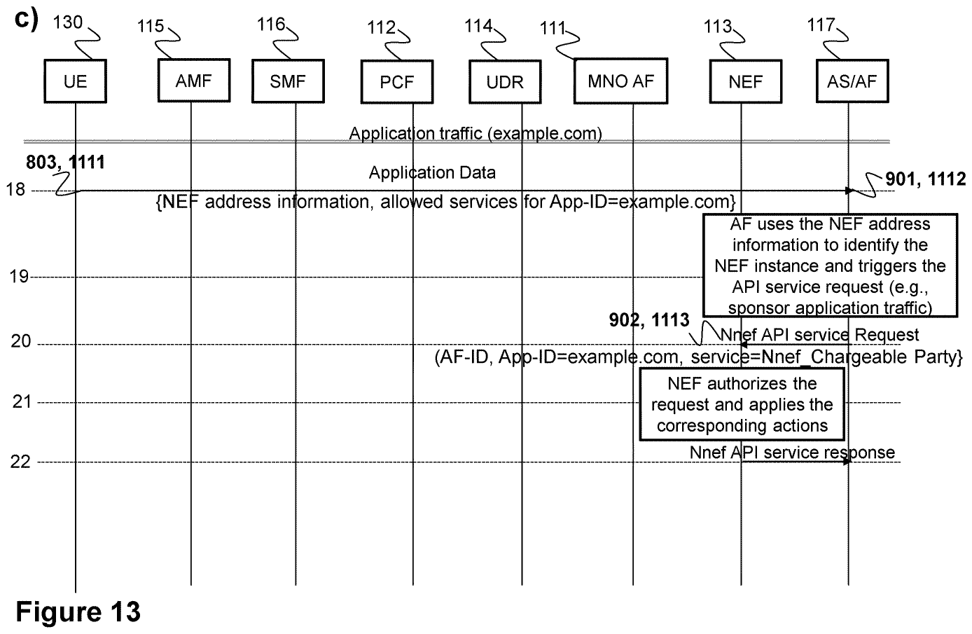

FIG. 13 is a signalling diagram depicting another non-limiting example of a method performed in the communications system 100, according to embodiments herein, over panels a), b) and c). Panel b) is a continuation of panel a) and panel c) is a continuation of panel b). FIG. 13 depicts a non-limiting example of the first group of embodiments, particularly of Nnef bootstrapping through ANIF. The sequence diagram is shown in FIG. 13 and shows an example where ANID is used to discover MNO's NEF and the MNO's NEF allowed APIs (services) for the subscriber's application session. The method of FIG. 13 may have as preconditions that, first, the MNO may have stored the list of CAPIF Core Function and NEF instances. It may be assumed this information is stored in UDR. Second, that the MNO may have stored the list of available NEF APIs (services) instances. It may be assumed this information is stored in UDR. Third, that the MNO may have stored the list of allowed services both on a per application basis and subscriber basis. It may be assumed this is stored in UDR, as subscriber data. And fourth, that the application client, e.g., App-ID=example.com, may support ANIF. In FIG. 13, the first node 111 is an MNO AF, the second node 112 is a PCF, the third node 113 is an NEF, the fourth node 114 is a UDR, the fifth node 115 is an AMF, the sixth node 116 is an SMF, the seventh node 117 is an AS/AF, the device 130 is a UE, and the endpoint 117 is an AS/AF. In Step 1, the device 130, triggers a PDU Session Establishment procedure. For simplicity reasons, not all steps are shown. Particularly, the device 130 sends an N1 PDU Session Establishment request to the fifth node 115. In Step 2, the fifth node 115 sends an Nsmf PDU Session Create Request the sixth node 116, including the identifier of the device 130 as a UE-ID. In Step 3, the sixth node 116 sends the request identifying a device 130 to the second node 112, as an Npcf_SMPolicyControl_Create Request, including the identifier of the device 130 as the UE-ID. The second node 112 receives the request in accordance with Action 1001 and Action 1101. In Step 4, the second node 112, in accordance with Action 1002 and Action 1102, queries the fourth node 114 for the information corresponding to the subscriber linked to the device 130. The second node 112 does this by sending a Nudr_Query Request to the fourth node 114 including the identifier of the device 130 as a UE-ID. In Step 5, the fourth node 114 looks for the NEF bootstrapping information and allowed services for the UE-ID. In step 6, in accordance with Action 1003 and Action 1103, the second node 112 retrieves from the UDR the session and subscriber data for UE-ID, which is extended with the following parameters: a) the NEF address information, which may be e.g., the URL or the IP address which may allow to identify the NEF and b) the list of (App-ID, allowed services). This may be understood to be the list of allowed services on a per application basis. For example, for App-ID=example.com, the following services may be allowed for the subscriber: i) QoS service (Nnef_AFsessionWithQoS service), so the content provider may be allowed to request a certain QoS for the application, and ii) sponsoring service, e.g., Nnef_ChargeableParty service, so the application data may be allowed to be sponsored by a third party, e.g., content provider, so it may not be deducted from the subscriber's monthly quota. The second node 112 may retrieve the information by receiving a Nudr_Query Response comprising {NEF address information, list of {App-ID, allowed services)}. In Step 7 and Step 8, in accordance with Action 1004 and Action 1104, the second node 112 may then forward the information retrieved in step 6 above to the first node 111. In embodiments herein, ANIF may be extended, e.g., through a Naf_Policy Request message including the NEF address information and the list of (App-ID, allowed services) for the subscriber session, which is received by the first node 111 in accordance with Action 701 and Action 1105. In Step 9, in accordance with Action 702 and Action 1106, the MNO AF stores the information received in step 8 above. In Step 10, the MNO answers the message in Step 8 indicating successful operation. In Step 11, the second node 112 answers the message in Step 3 by triggering a Npcf_SMPolicyControl_Create Response message. In Step 12, the sixth node 116, the SMF, answers the message in Step 2 by triggering a Nsmf PDU Session Create Response message. In Step 13, the fifth node 115, the AMF, answers the message in Step 1 by triggering a N1 PDU Session Establishment Response message. In steps 14 and 15, the device 130 opens an application, e.g., example.com. The application client, which supports ANIF, in accordance with Action 801 and Action 1107, triggers a connection with the first node 111, the MNO AF, and includes the following information: UE-ID, App-ID=example.com and the indication to request service information. The first node 111 receives this in accordance with Action 703 and Action 1108. In Steps 16 and 17 the first node 111, the MON AF, in accordance with Action 704 and Action 1109, answers with the stored information, at step 9 above, for the corresponding UE-ID and App-ID (example.com), including: the NEF address information, and the allowed services for App-ID=example.com, e.g., Nnef_ChargeableParty service and Nnef_AFsessionWithQoS service. The device 130 receives the information in accordance with Action 802 and Action 1110. In Step 18, the application client (example.com), in accordance with Action 803 and Action 1111, forwards the information received in step 17 to the endpoint 117, the application server. The endpoint 117 receives the information in accordance with Action 901 and Action 1112. In Step 19, the endpoint 117, based on the received information, decides to sponsor application data for the user application session. In Step 20, the endpoint 117, that is, the AS through an AF, uses the NEF address information to identify the NEF instance and triggers, in accordance with Action 902 and Action 1113, the API service request to sponsor application traffic through Nnef_ChargeableParty service, by sending an Nnef API service Request including the following information: the AF-ID, the App-ID=example.com, and the service=Nnef_ChargeableParty. In Steps 21 and 22, the third node 113, the NEF authorizes the request and applies the corresponding actions. In this example, the NEF will trigger towards the PCF a request to sponsor traffic for the subscriber's application session. This is not shown in the sequence diagram of FIG. 13 as it is based on existing procedures. The third node 113 also sends a Nnef API service response back to the endpoint 117 in Step 23.

As a summarized overview of the foregoing, it may be understood that, according to embodiments herein, the following mechanism may be performed: a UE application client, based on using client-network APIs, e.g. COPE or ANIF may: identify from which MNO it receives service, retrieve the information on MNO's NEF and supported API's, and provide the information to the application server. The application server, through an application function, may contact the NEF and trigger the selected NEF API/s. Embodiments herein may be applied to the following scenarios. In a first scenario, an SLA between the MNO and the content provider may exist. In this case, the MNO may share all the modifications to the configuration to use the Nnef APIs. This may provide the flexibility to move the server hosting the APIs and no hardcoded information may be needed. In a second scenario, there may be no SLA between the MNO and the content provider. In this case, the MNO may advertise the available services towards the content provider and allow the content provider to start communicating via Nnef APIs to start getting network services.

In summary, embodiments herein may a mechanism which may be based on using client-network APIs, e.g., COPE or ANIF, as a solution to discover an MNO's NEF and the MNO's NEF supported APIs for the application session of the subscriber.

Certain embodiments disclosed herein may provide one or more of the following technical advantage(s), which may be summarized as follows.

As a first advantage, embodiments herein may be understood to enable exposing the network service offerings of the communications system to applications and services without prior knowledge of what the network may offer.

As an additional advantage, embodiments herein may enable a quick update of network interface and resources to the already established services.

Embodiments herein may also provide the further advantage of enabling technologies such as dynamic SLA creation, and/or intent creation.

As yet a further advantage, embodiments herein may enable to solve the problems of deploying NEF and network services on the Internet.

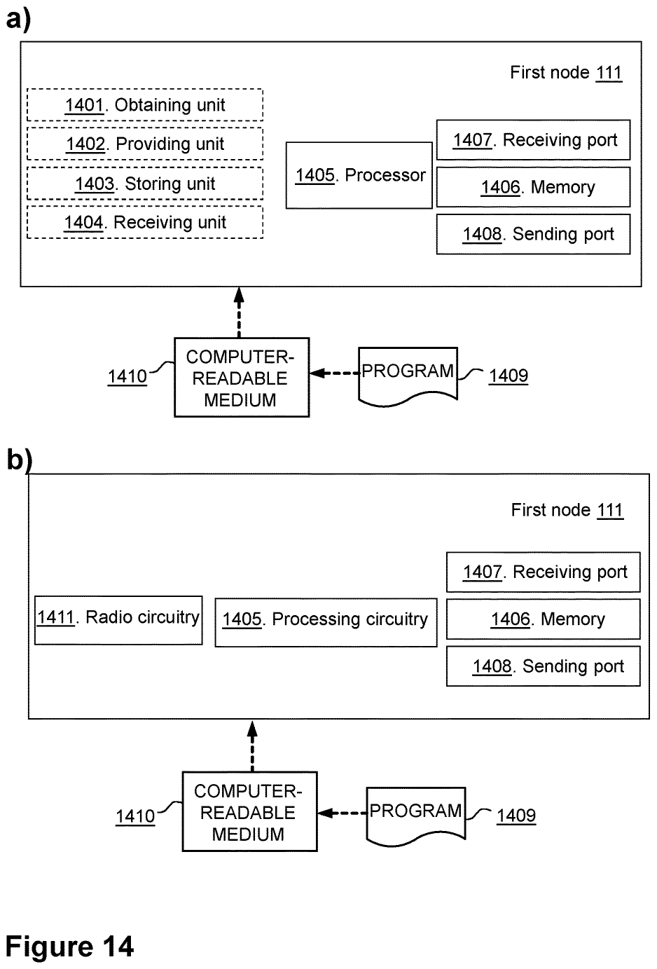

FIG. 14 depicts two different examples in panels a) and b), respectively, of the arrangement that the first node 111 may comprise to perform the method actions described above in relation to FIG. 7, FIGS. 12-13 and/or FIG. 11. In some embodiments, the first node 111 may comprise the following arrangement depicted in FIG. 14a. The first node 111 may be understood to be for handling the information in the communications system 100. The first node 111 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 14, optional boxes are indicated by dashed lines. The detailed description of some of the following corresponds to the same references provided above, in relation to the actions described for the first node 111 and will thus not be repeated here. For example, the address information of the third node 113 may be configured to be e.g., a URL or an IP address which may allow to identify the third node 113. Also, in some embodiments, at least one of the following may apply. The first node 111 may be configured to be one of: i) a UPF, a PGW-U, or a TDF-U operating in the communications system 100, ii) an AF, or a SCS/AS operating in the communications system 100, and iii) a SMF, a PGW-C, or a TDF-C operating in the communications system 100. The second node 112 may be configured to be a PCF, or a PCRF operating in the communications system 100. The third node 113 may be configured to be a NEF or a SCEF operating in the communications system 100. The device 130 may be configured to be a UE.

The first node 111 is configured to, e.g. by means of an obtaining unit 1401 within the first node 111 configured to, obtain, directly, or indirectly, from the second node 112 configured to operate in the communications system 100 the information corresponding to the subscriber configured to be linked to the device 130. The device 130 is configured to operate in the communications system 100. The information is configured to indicate the third node 113 configured to operate in the communications system 100 and being further configured to have the capability to expose the one or more services configured to be available at the communications system 100. The information is also configured to indicate at least a subset of the one or more services, configured to be allowed in the communications system 100 to the subscriber.

The first node 111 is also configured to, e.g. by means of a providing unit 1402 within the first node 111 configured to, provide the information configured to be obtained towards the device 130.

The first node 111 may be also configured to, e.g. by means of a storing unit 1403 within the first node 111 configured to, store the information configured to be obtained in the storage.

The first node 111 may be also configured to, e.g. by means of a receiving unit 1404 within the first node 111 configured to, receive the connection request from the device 130. In some of such embodiments, the information configured to be obtained may be configured to be retrieved from the storage and provided to the device 130 in response to the connection request configured to be received.

The information may be configured to indicate at least one of: a) the address information of the third node 113, and b) the list of the one or more services in the subset allowed to the subscriber, per respective application.

The embodiments herein may be implemented through one or more processors, such as a processor 1405 in the first node 111 depicted in FIG. 14, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 1406 comprising one or more memory units. The memory 1406 is arranged to be used to store obtained information, store data, configurations, schedulings, and applications etc. to perform the methods herein when being executed in the first node 111.

In some embodiments, the first node 111 may receive information from, e.g., the second node 112, the third node 113, the fourth node 114, the fifth node 115, the sixth node 116, the device 130, the endpoint 117, the radio network node 140 and/or another node through a receiving port 1407. In some examples, the receiving port 1407 may be, for example, connected to one or more antennas in the first node 111. In other embodiments, the first node 111 may receive information from another structure in the communications system 100 through the receiving port 1407. Since the receiving port 1407 may be in communication with the processor 1405, the receiving port 1407 may then send the received information to the processor 1405. The receiving port 1407 may also be configured to receive other information.

The processor 1405 in the first node 111 may be further configured to transmit or send information to e.g., the second node 112, the third node 113, the fourth node 114, the fifth node 115, the sixth node 116, the device 130, the endpoint 117, the radio network node 140, another node and/or another structure in the communications system 100, through a sending port 1408, which may be in communication with the processor 1405, and the memory 1406.

Those skilled in the art will also appreciate that any of the units 1401-1404 described above may refer to a combination of analog and digital circuits, and/or one or more processors configured with software and/or firmware, e.g., stored in memory, that, when executed by the one or more processors such as the processor 1405, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1401-1404 described above may be the processor 1405 of the first node 111, or an application running on such processor.

Thus, the methods according to the embodiments described herein for the first node 111 may be respectively implemented by means of a computer program 1409 product, comprising instructions, i.e., software code portions, which, when executed on at least one processor 1405, cause the at least one processor 1405 to carry out the actions described herein, as performed by the first node 111. The computer program 1409 product may be stored on a computer-readable storage medium 1140. The computer-readable storage medium 1140, having stored thereon the computer program 1409, may comprise instructions which, when executed on at least one processor 1405, cause the at least one processor 1405 to carry out the actions described herein, as performed by the first node 111. In some embodiments, the computer-readable storage medium 1140 may be a non-transitory computer-readable storage medium, such as a CD ROM disc, a memory stick, or stored in the cloud space. In other embodiments, the computer program 1409 product may be stored on a carrier containing the computer program, wherein the carrier is one of an electronic signal, optical signal, radio signal, or the computer-readable storage medium 1140, as described above.

The first node 111 may comprise an interface unit to facilitate communications between the first node 111 and other nodes or devices, e.g., the second node 112, the third node 113, the fourth node 114, the fifth node 115, the sixth node 116, the device 130, the endpoint 117, the radio network node 140, another node and/or another structure in the communications system 100. In some particular examples, the interface may, for example, include a transceiver configured to transmit and receive radio signals over an air interface in accordance with a suitable standard.

In other embodiments, the first node 111 may comprise the following arrangement depicted in FIG. 14b. The first node 111 may comprise a processing circuitry 1405, e.g., one or more processors such as the processor 1405, in the first node 111 and the memory 1406. The first node 111 may also comprise a radio circuitry 1411, which may comprise e.g., the receiving port 1407 and the sending port 1408. The processing circuitry 1405 may be configured to, or operable to, perform the method actions according to FIG. 7, FIGS. 12-13 and/or FIG. 11, in a similar manner as that described in relation to FIG. 14a. The radio circuitry 1411 may be configured to set up and maintain at least a wireless connection with the second node 112, the third node 113, the fourth node 114, the fifth node 115, the sixth node 116, the device 130, the endpoint 117, the radio network node 140, another node and/or another structure in the communications system 100.

Hence, embodiments herein also relate to the first node 111 operative for handling information in the communications system 100, the first node 111 is operative to operate in the communications system 100. The first node 111 may comprise the processing circuitry 1405 and the memory 1406, said memory 1406 containing instructions executable by said processing circuitry 1405, whereby the first node 111 is further operative to perform the actions described herein in relation to the first node 111, e.g., in FIG. 7, FIGS. 12-13 and/or FIG. 11.

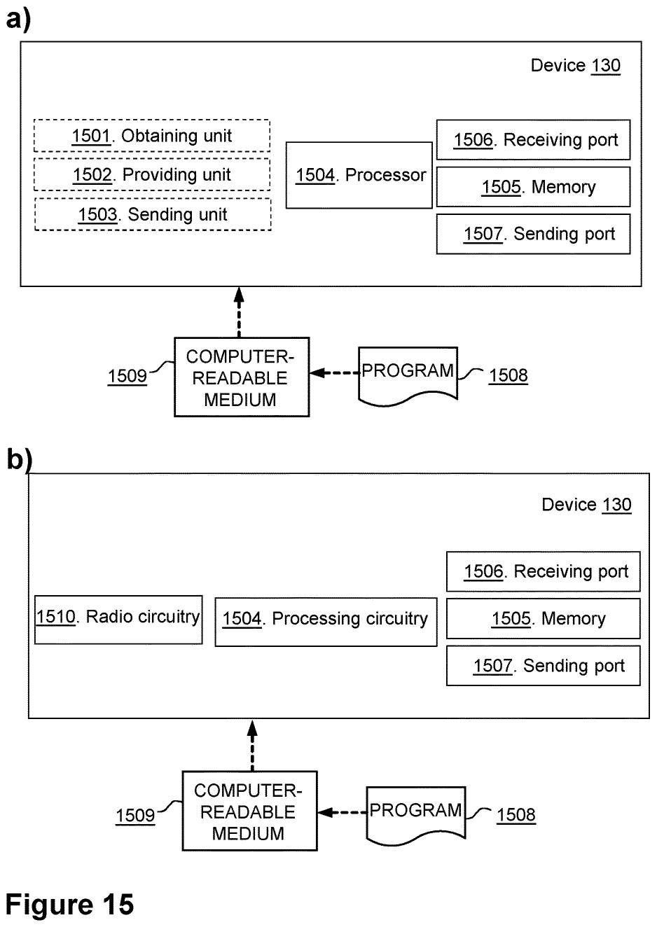

FIG. 15 depicts two different examples in panels a) and b), respectively, of the arrangement that the device 130, may comprise to perform the method actions described above in relation to FIG. 8, FIGS. 12-13 and/or FIG. 11. In some embodiments, the device 130 may comprise the following arrangement depicted in FIG. 15a. The device 130 may be understood to be for handling information in the communications system 100. The device 130 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 15, optional boxes are indicated by dashed lines. The detailed description of some of the following corresponds to the same references provided above, in relation to the actions described for the device 130 and will thus not be repeated here. For example, the address information of the third node 113 may be configured to be e.g., a URL or an IP address which may allow to identify the third node 113. Also, in some embodiments, at least one of the following may apply. The first node 111 may be configured to be one of: i) a UPF, a PGW-U, or a TDF-U operating in the communications system 100, ii) an AF, or a SCS/AS operating in the communications system 100, and iii) a SMF, a PGW-C, or a TDF-C operating in the communications system 100. The second node 112 may be configured to be a PCF, or a PCRF operating in the communications system 100. The third node 113 may be configured to be a NEF or a SCEF operating in the communications system 100. The endpoint 117 may be configured to be another AS, or another AF. The device 130 may be configured to be a UE.

The device 130 is configured to, e.g. by means of an obtaining unit 1501 within the device 130 configured to, obtain, directly, or indirectly, from the first node 111 configured to operate in the communications system 100, the information corresponding to the subscriber configured to be linked to the device 130. The information is configured to indicate the third node 113 configured to operate in the communications system 100. The third node 113 is further configured to have the capability to expose one or more services configured to be available at the communications system 100. The information is configured to indicate at least the subset of the one or more services, configured to be allowed in the communications system 100 to the subscriber.

The device 130 is configured to, e.g. by means of a providing unit 1502 within the device 130 configured to, provide the information configured to be obtained to the endpoint 117 of the data session with the device 130. The endpoint 117 is configured to operate outside of the communications system 100.

In some embodiments, the device 130 may be configured to, e.g. by means of a sending unit 1503 within the device 130 configured to, send the connection request to the first node 111. In some of such embodiments, the information may be configured to be obtained in response to the connection request configured to be sent.

In some embodiments, the connection request may be configured to indicate the first application. The information may be configured to indicate at least one of: a) the address information of the third node 113, and b) the first list of the one or more services configured to be comprised in the subset. The one or more services may be configured to be allowed to the subscriber for the first application configured to be indicated.

In some embodiments, the information configured to be obtained may be configured to be further based on a request to establish the session having been sent by the device 130 to another node 115 configured to operate in the communications system 100.

The embodiments herein may be implemented through one or more processors, such as a processor 1504 in the device 130 depicted in FIG. 15, together with computer program code for performing the functions and actions of the embodiments herein. The program code mentioned above may also be provided as a computer program product, for instance in the form of a data carrier carrying computer program code for performing the embodiments herein when being loaded into the in the device 130. One such carrier may be in the form of a CD ROM disc. It is however feasible with other data carriers such as a memory stick. The computer program code may furthermore be provided as pure program code on a server and downloaded to the device 130.

The device 130 may further comprise a memory 1505 comprising one or more memory units. The memory 1505 is arranged to be used to store obtained information, store data, configurations, schedulings, and applications etc. to perform the methods herein when being executed in the device 130.

In some embodiments, the device 130 may receive information from, e.g., the first node 111, the second node 112, the third node 113, the fourth node 114, the fifth node 115, the sixth node 116, the endpoint 117, the radio network node 140, and/or another node, through a receiving port 1506. In some examples, the receiving port 1506 may be, for example, connected to one or more antennas in the device 130. In other embodiments, the device 130 may receive information from another structure in the communications system 100 through the receiving port 1506. Since the receiving port 1506 may be in communication with the processor 1504, the receiving port 1506 may then send the received information to the processor 1504. The receiving port 1506 may also be configured to receive other information.

The processor 1504 in the device 130 may be further configured to transmit or send information to e.g., the first node 111, the second node 112, the third node 113, the fourth node 114, the fifth node 115, the sixth node 116, the endpoint 117, the radio network node 140, another node and/or another structure in the communications system 100, through a sending port 1507, which may be in communication with the processor 1504, and the memory 1505.

Those skilled in the art will also appreciate that any of the units 1501-1503 described above may refer to a combination of analog and digital circuits, and/or one or more processors configured with software and/or firmware, e.g., stored in memory, that, when executed by the one or more processors such as the processor 1504, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1501-1503 described above may be the processor 1504 of the device 130, or an application running on such processor.

Thus, the methods according to the embodiments described herein for the device 130 may be respectively implemented by means of a computer program 1508 product, comprising instructions, i.e., software code portions, which, when executed on at least one processor 1504, cause the at least one processor 1504 to carry out the actions described herein, as performed by the device 130. The computer program 1508 product may be stored on a computer-readable storage medium 1509. The computer-readable storage medium 1509, having stored thereon the computer program 1508, may comprise instructions which, when executed on at least one processor 1504, cause the at least one processor 1504 to carry out the actions described herein, as performed by the device 130. In some embodiments, the computer-readable storage medium 1509 may be a non-transitory computer-readable storage medium, such as a CD ROM disc, a memory stick, or stored in the cloud space. In other embodiments, the computer program 1508 product may be stored on a carrier containing the computer program, wherein the carrier is one of an electronic signal, optical signal, radio signal, or the computer-readable storage medium 1509, as described above.

The device 130 may comprise an interface unit to facilitate communications between the device 130 and other nodes or devices, e.g., the first node 111, the second node 112, the third node 113, the fourth node 114, the fifth node 115, the sixth node 116, the endpoint 117, the radio network node 140, another node and/or another structure in the communications system 100. In some particular examples, the interface may, for example, include a transceiver configured to transmit and receive radio signals over an air interface in accordance with a suitable standard.

In other embodiments, the device 130 may comprise the following arrangement depicted in FIG. 15b. The device 130 may comprise a processing circuitry 1504, e.g., one or more processors such as the processor 1504, in the device 130 and the memory 1505. The device 130 may also comprise a radio circuitry 1510, which may comprise e.g., the receiving port 1506 and the sending port 1507. The processing circuitry 1504 may be configured to, or operable to, perform the method actions according to FIG. 8, FIGS. 12-13 and/or FIG. 11, in a similar manner as that described in relation to FIG. 15a. The radio circuitry 1510 may be configured to set up and maintain at least a wireless connection with the first node 111, the second node 112, the third node 113, the fourth node 114, the fifth node 115, the sixth node 116, the endpoint 117, the radio network node 140, another node and/or another structure in the communications system 100.

Hence, embodiments herein also relate to the device 130 operative for handling information in the communications system 100, the device 130 being operative to operate in the communications system 100. The device 130 may comprise the processing circuitry 1504 and the memory 1505, said memory 1505 containing instructions executable by said processing circuitry 1504, whereby the device 130 is further operative to perform the actions described herein in relation to the device 130, e.g., in FIG. 8, FIGS. 12-13 and/or FIG. 11.

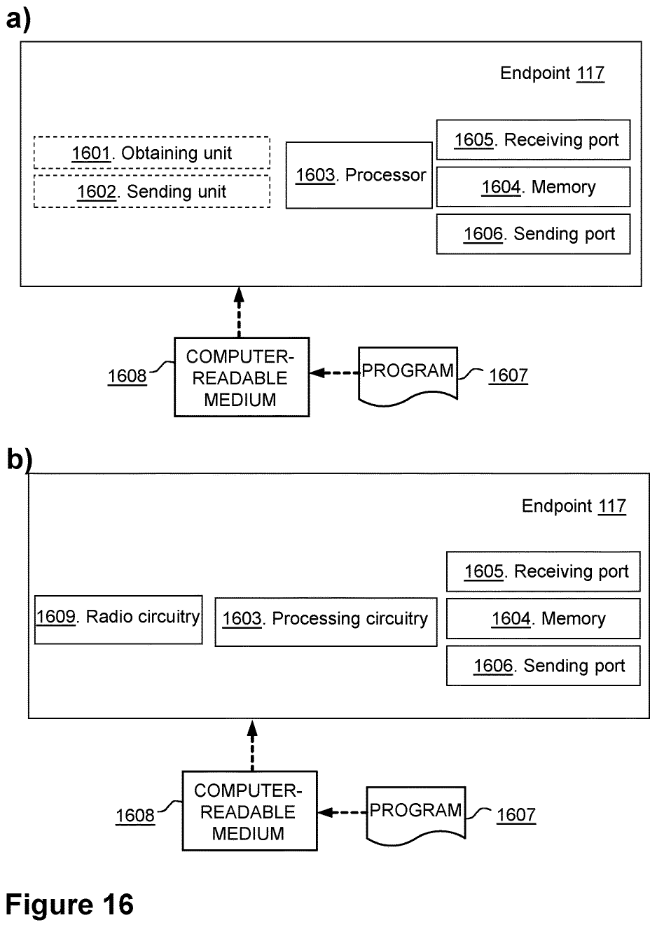

FIG. 16 depicts two different examples in panels a) and b), respectively, of the arrangement that the endpoint 117 configured to be of the data session with the device 130 may comprise to perform the method actions described above in relation to FIG. 9, FIGS. 12-13 and/or FIG. 11. In some embodiments, the endpoint 117 may comprise the following arrangement depicted in FIG. 16a. The endpoint 117 may be understood to be for handling information in the communications system 100. The endpoint 117 is configured to operate outside the communications system 100.

Several embodiments are comprised herein. Components from one embodiment may be tacitly assumed to be present in another embodiment and it will be obvious to a person skilled in the art how those components may be used in the other exemplary embodiments. In FIG. 16, optional boxes are indicated by dashed lines. The detailed description of some of the following corresponds to the same references provided above, in relation to the actions described for the endpoint 117 and will thus not be repeated here. For example, the address information of the third node 113 may be configured to be e.g., a URL or an IP address which may allow to identify the third node 113. Also, in some embodiments, at least one of the following may apply. The third node 113 may be configured to be a NEF or a SCEF operating in the communications system 100. The endpoint 117 may be configured to be another AS, or another AF. The device 130 may be configured to be a UE.

The endpoint 117 is configured to, e.g. by means of an obtaining unit 1601 within the endpoint 117 configured to, obtain, from the device 130 configured to operate in the communications system 100, the information corresponding to the subscriber configured to be linked to the device 130. The information is configured to indicate the third node 113 configured to operate in the communications system 100. The third node 113 is further configured to have the capability to expose the one or more services configured to be available at the communications system 100. The information is further configured to indicate at least the subset of the one or more services, configured to be allowed in the communications system 100 to the subscriber.

The endpoint 117 is also configured to, e.g. by means of a sending unit 1602 within the endpoint 117 configured to, send the indication to the third node 113 configured to be indicated in the information. The indication is configured to request one of the one or more services in the subset.

The information may be configured to indicate at least one of: a) the address information of the third node 113, and b) the first list of the one or more services configured to be comprised in the subset, the one or more services being configured to be allowed for the first application configured to be indicated by the device 130.

The embodiments herein may be implemented through one or more processors, such as a processor 1603 in the endpoint 117 depicted in FIG. 16, together with computer program code for performing the functions and actions of the embodiments herein. The program code mentioned above may also be provided as a computer program product, for instance in the form of a data carrier carrying computer program code for performing the embodiments herein when being loaded into the in the endpoint 117. One such carrier may be in the form of a CD ROM disc. It is however feasible with other data carriers such as a memory stick. The computer program code may furthermore be provided as pure program code on a server and downloaded to the endpoint 117.

The endpoint 117 may further comprise a memory 1604 comprising one or more memory units. The memory 1604 is arranged to be used to store obtained information, store data, configurations, schedulings, and applications etc. to perform the methods herein when being executed in the endpoint 117.

In some embodiments, the endpoint 117 may receive information from, e.g., the first node 111, the second node 112, the third node 113, the fourth node 114, the fifth node 115, the sixth node 116, the device 130, the radio network node 140, and/or another node, through a receiving port 1605. In some examples, the receiving port 1605 may be, for example, connected to one or more antennas in the endpoint 117. In other embodiments, the endpoint 117 may receive information from another structure in the communications system 100 through the receiving port 1605. Since the receiving port 1605 may be in communication with the processor 1603, the receiving port 1605 may then send the received information to the processor 1603. The receiving port 1605 may also be configured to receive other information.

The processor 1603 in the endpoint 117 may be further configured to transmit or send information to e.g., the first node 111, the second node 112, the third node 113, the fourth node 114, the fifth node 115, the sixth node 116, the device 130, the radio network node 140, another node and/or another structure in the communications system 100, through a sending port 1606, which may be in communication with the processor 1603, and the memory 1604.

Those skilled in the art will also appreciate that the units 1601-1602 described above may refer to a combination of analog and digital circuits, and/or one or more processors configured with software and/or firmware, e.g., stored in memory, that, when executed by the one or more processors such as the processor 1603, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The units 1601-1602 described above may be the processor 1603 of the endpoint 117, or an application running on such processor.

Thus, the methods according to the embodiments described herein for the endpoint 117 may be respectively implemented by means of a computer program 1607 product, comprising instructions, i.e., software code portions, which, when executed on at least one processor 1603, cause the at least one processor 1603 to carry out the actions described herein, as performed by the endpoint 117. The computer program 1607 product may be stored on a computer-readable storage medium 1608. The computer-readable storage medium 1608, having stored thereon the computer program 1607, may comprise instructions which, when executed on at least one processor 1603, cause the at least one processor 1603 to carry out the actions described herein, as performed by the endpoint 117. In some embodiments, the computer-readable storage medium 1608 may be a non-transitory computer-readable storage medium, such as a CD ROM disc, a memory stick, or stored in the cloud space. In other embodiments, the computer program 1607 product may be stored on a carrier containing the computer program, wherein the carrier is one of an electronic signal, optical signal, radio signal, or the computer-readable storage medium 1608, as described above.

The endpoint 117 may comprise an interface unit to facilitate communications between the endpoint 117 and other nodes or devices, e.g., the first node 111, the second node 112, the third node 113, the fourth node 114, the fifth node 115, the sixth node 116, the device 130, the radio network node 140, another node and/or another structure in the communications system 100. In some particular examples, the interface may, for example, include a transceiver configured to transmit and receive radio signals over an air interface in accordance with a suitable standard.

In other embodiments, the endpoint 117 may comprise the following arrangement depicted in FIG. 16b. The endpoint 117 may comprise a processing circuitry 1603, e.g., one or more processors such as the processor 1603, in the endpoint 117 and the memory 1604. The endpoint 117 may also comprise a radio circuitry 1609, which may comprise e.g., the receiving port 1605 and the sending port 1606. The processing circuitry 1603 may be configured to, or operable to, perform the method actions according to FIG. 9, FIGS. 12-13 and/or FIG. 11, in a similar manner as that described in relation to FIG. 16a. The radio circuitry 1609 may be configured to set up and maintain at least a wireless connection with the first node 111, the second node 112, the third node 113, the fourth node 114, the fifth node 115, the sixth node 116, the device 130, the radio network node 140, another node and/or another structure in the communications system 100.

Hence, embodiments herein also relate to the endpoint 117 operative for handling information in the communications system 100, the endpoint 117 being operative to operate in the communications system 100. The endpoint 117 may comprise the processing circuitry 1603 and the memory 1604, said memory 1604 containing instructions executable by said processing circuitry 1603, whereby the endpoint 117 is further operative to perform the actions described herein in relation to the endpoint 117, e.g., in FIG. 9, FIGS. 12-13 and/or FIG. 11.

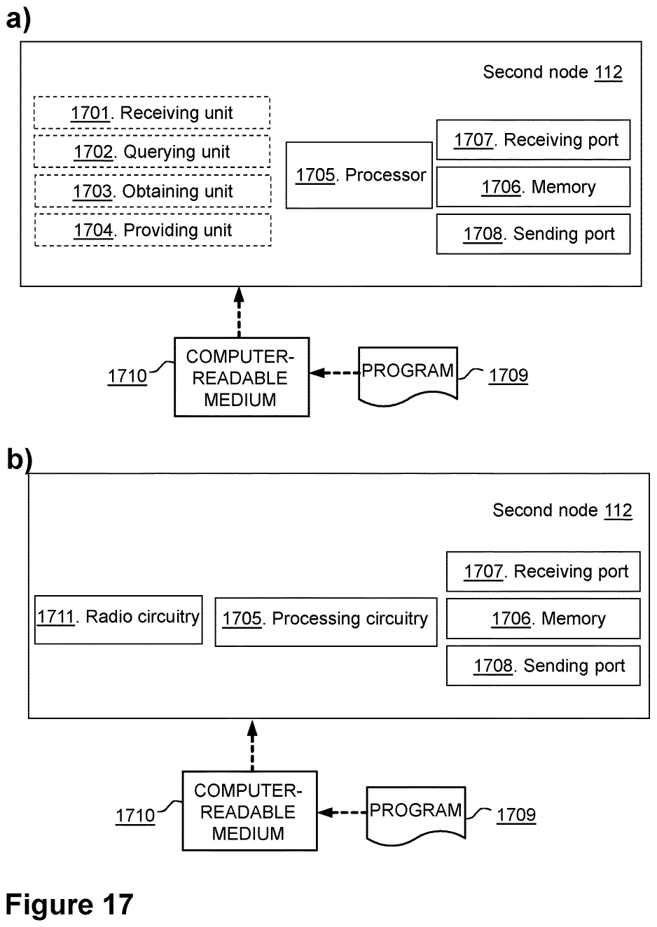

FIG. 17 depicts two different examples in panels a) and b), respectively, of the arrangement that the second node 112 may comprise to perform the method actions described above in relation to FIG. 10, FIGS. 12-13 and/or FIG. 11. In some embodiments, the second node 112 may comprise the following arrangement depicted in FIG. 17a. The second node 112 may be understood to be for handling the information in the communications system 100. The second node 112 is configured to operate in the communications system 100.

Several embodiments are comprised herein. Components from one embodiment may be tacitly assumed to be present in another embodiment and it will be obvious to a person skilled in the art how those components may be used in the other exemplary embodiments. In FIG. 17, optional boxes are indicated by dashed lines. The detailed description of some of the following corresponds to the same references provided above, in relation to the actions described for the second node 112 and will thus not be repeated here. For example, the address information of the third node 113 may be configured to be e.g., a URL or an IP address which may allow to identify the third node 113. Also, in some embodiments, at least one of the following may apply. The first node 111 may be configured to be one of: i) a UPF, a PGW-U, or a TDF-U operating in the communications system 100, ii) an AF, or a SCS/AS operating in the communications system 100, and iii) a SMF, a PGW-C, or a TDF-C operating in the communications system 100. The second node 112 may be configured to be a PCF, or a PCRF operating in the communications system 100. The third node 113 may be configured to be a NEF or a SCEF operating in the communications system 100. The fourth node 114 may be configured to be a UDR, or an SPR operating in the communications system 100. The device 130 may be configured to be a UE.

The second node 112 is configured to, e.g. by means of a receiving unit 1701 within the second node 112 configured to, receive the request configured to identify the device 130.

The second node 112 is also configured to, e.g. by means of a querying unit 1702 within the second node 112 configured to, query the fourth node 114 configured to operate in the communications system 100 for the information corresponding to the subscriber configured to be linked to the device 130.

The second node 112 may be also configured to, e.g. by means of an obtaining unit 1703 within the second node 112 configured to, obtain the information from the fourth node 114. The information is configured to indicate the third node 113 configured to operate in the communications system 100. The third node 113 is further configured to have the capability to expose the one or more services configured to be available at the communications system 100. The information is also configured to indicate at least the subset of the one or more services, configured to be allowed in the communications system 100 to the subscriber.

The second node 112 may be also configured to, e.g. by means of a providing unit 1704 within the second node 112 configured to, provide the information configured to be obtained towards the device 130 or to the first node 111 configured to operate in the communications system 100.

The set of information may be configured to indicate at least one of: a) the address information of the third node 113, and b) the list of the one or more services in the subset configured to be allowed to the subscriber, per respective application.

The embodiments herein may be implemented through one or more processors, such as a processor 1705 in the second node 112 depicted in FIG. 17, together with computer program code for performing the functions and actions of the embodiments herein. The program code mentioned above may also be provided as a computer program product, for instance in the form of a data carrier carrying computer program code for performing the embodiments herein when being loaded into the in the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 1706 comprising one or more memory units. The memory 1706 is arranged to be used to store obtained information, store data, configurations, schedulings, and applications etc. to perform the methods herein when being executed in the second node 112.

In some embodiments, the second node 112 may receive information from, e.g., the first node 111, the third node 113, the fourth node 114, the fifth node 115, the sixth node 116, the device 130, the endpoint 117 the radio network node 140, and/or another node through a receiving port 1707. In some examples, the receiving port 1707 may be, for example, connected to one or more antennas in the second node 112. In other embodiments, the second node 112 may receive information from another structure in the communications system 100 through the receiving port 1707. Since the receiving port 1707 may be in communication with the processor 1705, the receiving port 1707 may then send the received information to the processor 1705. The receiving port 1707 may also be configured to receive other information.

The processor 1705 in the second node 112 may be further configured to transmit or send information to e.g., the first node 111, the third node 113, the fourth node 114, the fifth node 115, the sixth node 116, the device 130, the endpoint 117 the radio network node 140, another node and/or another structure in the communications system 100, through a sending port 1708, which may be in communication with the processor 1705, and the memory 1706.

Those skilled in the art will also appreciate that any of the units 1701-1704 described above may refer to a combination of analog and digital circuits, and/or one or more processors configured with software and/or firmware, e.g., stored in memory, that, when executed by the one or more processors such as the processor 1705, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 1701-1704 described above may be the processor 1705 of the second node 112, or an application running on such processor.

Thus, the methods according to the embodiments described herein for the second node 112 may be respectively implemented by means of a computer program 1709 product, comprising instructions, i.e., software code portions, which, when executed on at least one processor 1705, cause the at least one processor 1705 to carry out the actions described herein, as performed by the second node 112. The computer program 1709 product may be stored on a computer-readable storage medium 1170. The computer-readable storage medium 1170, having stored thereon the computer program 1709, may comprise instructions which, when executed on at least one processor 1705, cause the at least one processor 1705 to carry out the actions described herein, as performed by the second node 112. In some embodiments, the computer-readable storage medium 1170 may be a non-transitory computer-readable storage medium, such as a CD ROM disc, a memory stick, or stored in the cloud space. In other embodiments, the computer program 1709 product may be stored on a carrier containing the computer program, wherein the carrier is one of an electronic signal, optical signal, radio signal, or the computer-readable storage medium 1170, as described above.

The second node 112 may comprise an interface unit to facilitate communications between the second node 112 and other nodes or devices, e.g., the first node 111, the third node 113, the fourth node 114, the fifth node 115, the sixth node 116, the device 130, the endpoint 117 the radio network node 140, another node and/or another structure in the communications system 100. In some particular examples, the interface may, for example, include a transceiver configured to transmit and receive radio signals over an air interface in accordance with a suitable standard.

In other embodiments, the second node 112 may comprise the following arrangement depicted in FIG. 17b. The second node 112 may comprise a processing circuitry 1705, e.g., one or more processors such as the processor 1705, in the second node 112 and the memory 1706. The second node 112 may also comprise a radio circuitry 1711, which may comprise e.g., the receiving port 1707 and the sending port 1708. The processing circuitry 1705 may be configured to, or operable to, perform the method actions according to FIG. 10, FIGS. 12-13 and/or FIG. 11, in a similar manner as that described in relation to FIG. 17a. The radio circuitry 1711 may be configured to set up and maintain at least a wireless connection with the first node 111, the third node 113, the fourth node 114, the fifth node 115, the sixth node 116, the device 130, the endpoint 117 the radio network node 140, another node and/or another structure in the communications system 100.

Hence, embodiments herein also relate to the second node 112 operative for handling information in the communications system 100, the second node 112 is operative to operate in the communications system 100. The second node 112 may comprise the processing circuitry 1705 and the memory 1706, said memory 1706 containing instructions executable by said processing circuitry 1705, whereby the second node 112 is further operative to perform the actions described herein in relation to the second node 112, e.g., in FIG. 10, FIGS. 12-13 and/or FIG. 11.

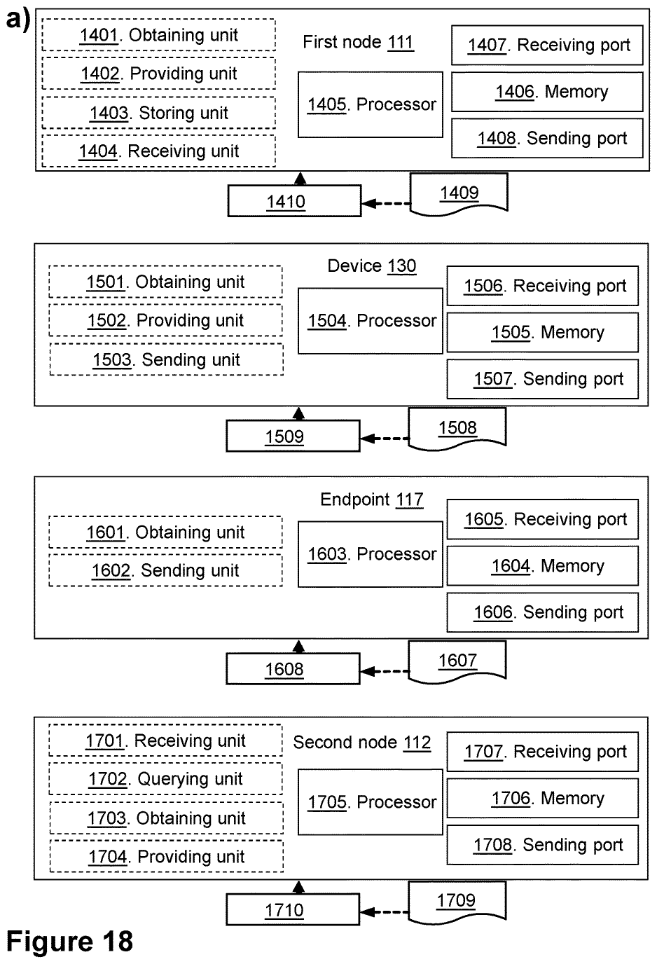

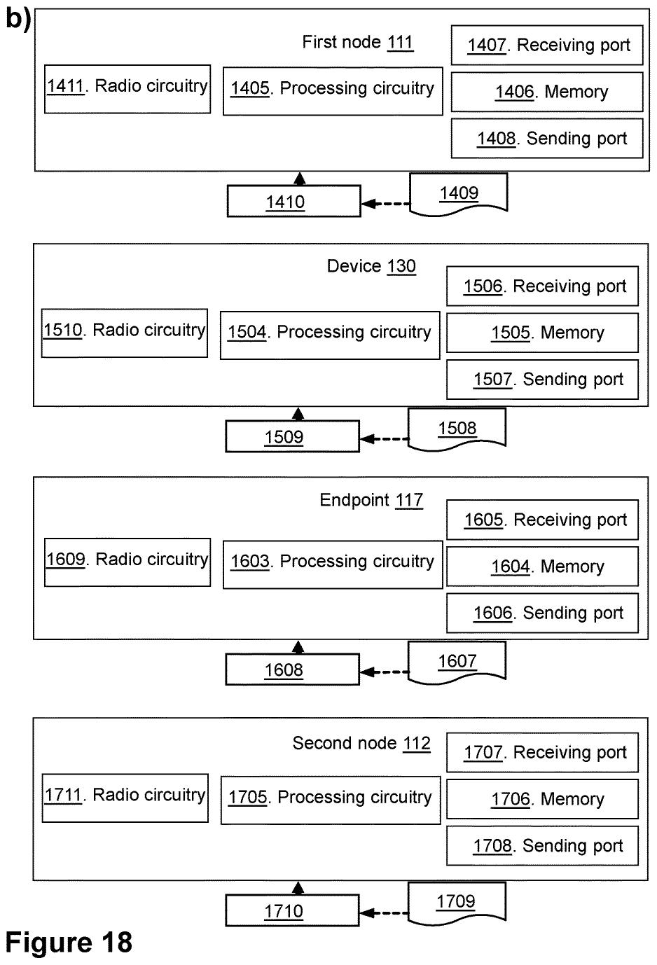

FIG. 18 depicts two different examples in panels a) and b), respectively, of the arrangement that the communications system 100 may comprise to perform the method actions described above in relation to FIG. 11 and/or FIGS. 12-13. The arrangement depicted in panel a) corresponds to that described in relation to panel a) in FIG. 14, FIG. 15, FIG. 16 and FIG. 17 for each of the first node 111, the device 130, the endpoint 117 and the second node 112, respectively. The arrangement depicted in panel b) corresponds to that described in relation to panel b) in FIG. 14, FIG. 15, FIG. 16 and FIG. 17 for each of the first node 111, the device 130, the endpoint 117 and the second node 112, respectively. The communications system 100 may be for handling information in the communications system 100. The communications system 100 is configured to comprise the first node 111, the second node 112 and the device 130.

Several embodiments are comprised herein. Components from one embodiment may be tacitly assumed to be present in another embodiment and it will be obvious to a person skilled in the art how those components may be used in the other exemplary embodiments. In FIG. 17, optional boxes are indicated by dashed lines. The detailed description of some of the following corresponds to the same references provided above, in relation to the actions described for the second node 112 and will thus not be repeated here. For example, the address information of the third node 113 may be configured to be e.g., a URL or an IP address which may allow to identify the third node 113. Also, in some embodiments, at least one of the following may apply. The first node 111 may be configured to be one of: i) a UPF, a PGW-U, or a TDF-U operating in the communications system 100, ii) an AF, or a SCS/AS operating in the communications system 100, and iii) a SMF, a PGW-C, or a TDF-C operating in the communications system 100. The second node 112 may be configured to be a PCF, or a PCRF operating in the communications system 100. The third node 113 may be configured to be a NEF or a SCEF operating in the communications system 100. The endpoint 117 may be configured to be another AS, or another AF. The device 130 may be configured to be a UE.

The communications system 100 is configured to, e.g. by means of the obtaining unit 1401 within the first node 111 configured to, obtain, by the first node 111, directly, or indirectly, from the second node 112 configured to operate in the communications system 100 the information corresponding to the subscriber configured to be linked to the device 130. The device 130 is configured to operate in the communications system 100. The information is configured to indicate the third node 113 configured to operate in the communications system 100 and being further configured to have the capability to expose the one or more services configured to be available at the communications system 100. The information is also configured to indicate at least the subset of the one or more services, configured to be allowed in the communications system 100 to the subscriber.

The communications system 100 is also configured to, e.g. by means of the providing unit 1402 within the first node 111 configured to, provide, by the first node 111, the information configured to be obtained towards the device 130.

The communications system 100 is configured to, e.g. by means of the obtaining unit 1501 within the device 130 configured to, obtain, by the device 130, the information directly, or indirectly, from the first node 111.

The communications system 100 is also configured to, e.g. by means of the providing unit 1502 within the device 130 configured to, provide, by the device 130, the information configured to be obtained to the endpoint 117 of the data session with the device 130. The endpoint 117 is configured to operate outside of the communications system 100.

The communications system 100 is further configured to, e.g. by means of the obtaining unit 1601 within the endpoint 117 configured to, obtain, by the endpoint 117, the information from the device 130 configured to operate in the communications system 100, corresponding to the subscriber configured to be linked to the device 130.

The communications system 100 is also configured to, e.g. by means of the sending unit 1602 within the endpoint 117 configured to, send, by the endpoint 117, the indication to the third node 113 configured to be indicated in the information. The indication is configured to request one of the one or more services in the subset.

The communications system 100 may be further configured to, e.g. by means of the receiving unit 1701 within the second node 112 configured to, receive, by the second node 112, the request configured to identify the device 130.

The communications system 100 may be further configured to, e.g. by means of the querying unit 1702 within the second node 112 configured to, query, by the second node 112, the fourth node 114 configured to operate in the communications system 100 for the information corresponding to the subscriber configured to be linked to the device 130.

The communications system 100 may be further configured to, e.g. by means of the obtaining unit 1703 within the second node 112 configured to, obtain, by the second node 112, the information from the fourth node 114.

The communications system 100 may be further configured to, e.g. by means of the providing unit 1704 within the second node 112 configured to, provide, by the second node 112, the information configured to be obtained towards the device 130 or to the first node 111 configured to operate in the communications system 100.

The fourth node 114 may be configured to be a UDR, or an SPR operating in the communications system 100.

The information may be configured to indicate at least one of: a) the address information of the third node 113, and b) the list of the one or more services in the subset configured to be allowed to the subscriber, per respective application.

The communications system 100 may be further configured to, e.g., by means of the storing unit 1403 within the first node 111 configured to, store, by the first node 111, the information configured to be obtained in the storage.

The communications system 100 may be further configured to, e.g., by means of the sending unit 1503 within the device 130 configured to, send, by the device 130, the connection request to the first node 111. In some of such embodiments, the information may be configured to be obtained in response to the connection request configured to be sent.

The communications system 100 may be further configured to, e.g., by means of the receiving unit 1404 within the first node 111 configured to, receive, by the first node 111, the connection request from the device 130. In some of such embodiments, the information configured to be obtained may be configured to be retrieved from the storage and provided to the device 130 in response to the connection request configured to be received.

In some embodiments, the connection request may be configured to indicate the first application. The information may be configured to indicate at least one of: a) the address information of the third node 113, and b) the first list of the one or more services configured to be comprised in the subset. The one or more services may be configured to be allowed to the subscriber for the first application configured to be indicated.

In some embodiments, the information configured to be obtained may be further configured to be based on the request to establish the session having been sent by the device 130 to the another node 115 configured to operate in the communications system 100.

The fourth node 114 may be configured to be a UDR, or an SPR operating in the communications system 100.

The remaining configurations described for the first node 111, the device 130, the endpoint 117 and the second node 112, in relation to FIG. 18, may be understood to correspond to those described in FIG. 14, FIG. 15, FIG. 16 and FIG. 17, respectively, and to be performed, e.g., by means of the corresponding units and arrangements described in FIG. 14, FIG. 15, FIG. 16 and FIG. 17, which will not be repeated here.

When using the word “comprise” or “comprising”, it shall be interpreted as non-limiting, i.e. meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

1. A computer-implemented method, performed by a first node, for handling information in a communications system, the first node operating in the communications system, the method comprising:
obtaining, directly, or indirectly, from a second node operating in the communications system information corresponding to a subscriber linked to a device operating in the communications system, the information indicating:
i. a third node operating in the communications system having a capability to expose one or more services available at the communications system, and
ii. at least a subset of the one or more services, allowed in the communications system to the subscriber, and
providing the obtained information towards the device.

2. The method according to claim 1, the method further comprising:
storing the obtained information in a storage, and
receiving a connection request from the device, and
wherein the obtained information is retrieved from the storage and provided to the device in response to the received connection request.

3. The method according to claim 1, wherein the information indicates at least one of:
a. address information of the third node, and
b. a list of the one or more services in the subset allowed to the subscriber, per respective application.

4. The method according to claim 1, wherein at least one of:
a. the first node is one of: i) a User Plane Function, UPF, a Packet Data Network Gateway User plane function, PGW-U, or a Traffic Detection Function User plane, TDF-U, operating in the communications system, ii) an Application Function, AF, or a Service Capability Server/Application Server, SCS/AS, operating in the communications system, and iii) a Session Management Function, SMF, a Packet Data Network Gateway Control plane function, PGW-C, or a Traffic Detection Function Control plane, TDF-C, operating in the communications system,
b. the second node is a Policy Charging Function, PCF, or a Policy and Charging Rule Function, PCRF, operating in the communications system,
c. the third node is a Network Exposure Function, NEF, or a Service Capability Exposure Function, SCEF, operating in the communications system, and
d. the device is a user equipment.

5. A computer-implemented method, performed by a device, for handling information in a communications system, the device operating in the communications system, the method comprising:
obtaining, directly, or indirectly, from a first node operating in the communications system information corresponding to a subscriber linked to the device, the information indicating:
i. a third node operating in the communications system having a capability to expose one or more services available at the communications system, and
ii. at least a subset of the one or more services, allowed in the communications system to the subscriber, and
providing the obtained information to an endpoint of a data session with the device, wherein the endpoint operates outside of the communications system.

6. The method according to claim 5, the method further comprising:
sending a connection request to the first node, and
wherein the information is obtained in response to the sent connection request.

7. The method according to claim 6, wherein the connection request indicates a first application, and wherein the information indicates at least one of:
a. address information of the third node, and
b. a first list of the one or more services comprised in the subset, the one or more services being allowed to the subscriber for the indicated first application.

8. The method according to claim 5, the obtained information being further based on a request to establish a session having been sent by the device to another node operating in the communications system.

9. The method according to claim 5, wherein at least one of:
a. the first node is one of: i) a User Plane Function, UPF, a Packet Data Network Gateway User plane function, PGW-U, or a Traffic Detection Function User plane, TDF-U, operating in the communications system, ii) an Application Function, AF, or a Service Capability Server/Application Server, SCS/AS, operating in the communications system, and iii) a Session Management Function, SMF, a Packet Data Network Gateway Control plane function, PGW-C, or a Traffic Detection Function Control plane, TDF-C, operating in the communications system,
b. the second node is a Policy Charging Function, PCF, or a Policy and Charging Rule Function, PCRF, operating in the communications system,
c. the third node is a Network Exposure Function, NEF, or a Service Capability Exposure Function, SCEF, operating in the communications system,
d. the endpoint is another AS, or another AF, and
e. the device is a user equipment.

10. A computer-implemented method, performed by an endpoint of a data session, with a device the method being for handling information in a communications system, the endpoint operating outside the communications system, the method comprising:
obtaining, from the device operating in the communications system, information corresponding to a subscriber linked to the device, the information indicating:
i. a third node operating in the communications system having a capability to expose one or more services available at the communications system, and
ii. at least a subset of the one or more services, allowed in the communications system to the subscriber, and
sending an indication to the third node indicated in the information, the indication requesting one of the one or more services in the subset.

11. The method according to claim 10, wherein the information indicates at least one of:
a. address information of the third node, and
b. a first list of the one or more services comprised in the subset, the one or more services being allowed for a first application indicated by the device.

12. The method according to claim 10, wherein at least one of:
a. the third node is a Network Exposure Function, NEF, or a Service Capability Exposure Function, SCEF, operating in the communications system,
b. the endpoint is another AS, or another AF, and
c. the device is a user equipment.

13. A computer-implemented method, performed by a second node, for handling information in a communications system, the second node operating in the communications system, the method comprising:
receiving a request identifying a device,
querying a fourth node operating in the communications system for information corresponding to a subscriber linked to the device,
obtaining the information from the fourth node, the information indicating:
i. a third node operating in the communications system having a capability to expose one or more services available at the communications system, and
ii. at least a subset of the one or more services, allowed in the communications system to the subscriber, and
providing the obtained information towards the device or to a first node operating in the communications system.

14. The method according to claim 13, wherein the set of information indicates at least one of:
a. address information of the third node, and
b. a list of the one or more services in the subset allowed to the subscriber, per respective application.

15. The method according to claim 13, wherein at least one of:
a. the first node is one of: i) a User Plane Function, UPF, a Packet Data Network Gateway User plane function, PGW-U, or a Traffic Detection Function User plane, TDF-U, operating in the communications system, ii) an Application Function, AF, or a Service Capability Server/Application Server, SCS/AS, operating in the communications system, and iii) a Session Management Function, SMF, a Packet Data Network Gateway Control plane function, PGW-C, or a Traffic Detection Function Control plane, TDF-C, operating in the communications system,
b. the second node is a Policy Charging Function, PCF, or a Policy and Charging Rule Function, PCRF, operating in the communications system,
c. the third node is a Network Exposure Function, NEF, or a Service Capability Exposure Function, SCEF, operating in the communications system,
d. the fourth node is a Unified Data Repository, UDR, or a Subscriber Profile Repository, SPR, operating in the communications system, and
e. the device is a user equipment.

16-46. (canceled)
